(19) United States
(12) Patent Application Publication
(10) Pub. No.: US 2006/0066573 A1
(43) Pub. Date: Mar. 30, 2006

(54) Device control system

(75) Inventor: Yuji Matsumoto, Yokohama (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/034,324

(22) Filed: Jan. 12, 2005

(30) Foreign Application Priority Data
Sep. 24, 2004 (JP) 2004-276436

(51) Int. Cl. G09G 5/08

(52) U.S. Cl. 345/158

(57) ABSTRACT

A device control system allows a terminal owned by the user to control the functions of various connected devices as if through operation panels of those devices. A control requester sends a terminal message including coordinate information of a display screen and an identifier of the terminal for making a control request. A display controller displays on the display screen a search category of control items, the functions that can be provided by another device, and events in a display mode based on event detail information. A control request processor sends a control request message to the other device in response to operation of the events displayed on the display screen. A control request response processor receives the terminal message, manages the terminal as a terminal for controlling itself based on the identifier, assigns events controllable by the user to relative positions of coordinates recognized from the coordinate information, thereby generating the event detail information, and sends the event detail information. A function executing unit receives the control request message and executes a function corresponding thereto.

### CROSS-REFERENCE TO RELATED APPLICATIONS

This application is based upon and claims the benefits of priority from the prior Japanese Patent Application No. 2004-276436, filed on Sep. 24, 2004, the entire contents of which are incorporated herein by reference.

### BACKGROUND OF THE INVENTION

(1) Field of the Invention

The present invention relates to a device control system, and more particularly to a device control system for allowing a user's own terminal to control the functions of another device.

(2) Description of the Related Art

As the information and communications technology is highly developed today, information-processing devices including information terminals and cellular phones find themselves everywhere. In this environment, it is expected to realize an information-intensive society based on ubiquitous computing accessible for required processing anytime anywhere.

In recent years, attention has been drawn to a technology called “augmented reality” (AR) where the real world is augmented based on the positive utilization of situations (things and user positions in the real world, etc.) in the real world.

Unlike virtual reality that makes a space present only in data look like reality, augmented reality is a technology wherein a virtual space generated by the computer and a real space as experienced by the user are combined in one-to-one correspondence, and a virtual scene is added to a real scene to make the virtual space and the real space look as if combined together.

One example of augmented reality system is a head-mounted display (HMD) applied to a digital museum. When a visitor to the digital museum wears a HMD and sees articles on exhibit, the HMD displays information about the articles over the real scene and runs a description of the articles.

By providing visitors with an environment (augmented reality environment) where the real world is seen in combination with the virtual world, the museum makes the individual visitors interested in objects on exhibit and gives the visitors information to meets the interests.

According to a conventional augmented reality system, a manipulative environment is provided for selecting desired identifying information from an image that captures a real-world scene containing visible identifying information (see, for example, Japanese Unexamined patent publication No. 2003-323239, paragraphs 0034 to 0041 and FIG. 1).

The conventional augmented reality technology has been realized in limited areas by very large-scale systems, such as in a certain facility (e.g., a digital museum) where information specialized in the facility (e.g., exhibit information) is available through a certain device (e.g., HMD). There has not been available a system for giving the user a handier augmented reality environment.

According to the conventional augmented reality system disclosed in Japanese Unexamined patent publication No. 2003-323239, a light beacon is placed on an object, e.g., an advertisement, a building, or the like, in the real world, and information transmitted in the form of an optical signal from the light beacon is acquired by an information terminal combined with a camera to construct augmented reality. For example, a light beacon for transmitting ID information of a movie is placed near a poster of the movie, and when the user sees the poster with an information terminal combined with a camera, the information terminal acquires the ID information from the light beacon, and displays a trailer of the movie on its screen.

Since the conventional augmented reality system provides the user with an optical signal representing information depending on real-world objects that are present in sight, the user passively obtains visual information as with the digital museum augmented reality system described above.

The conventional augmented reality system mainly operates to give the user primarily visual information, and is unable to allow the user to enter an augmented reality scene for exchanging information.

A space in which the user is allowed to exchange information in augmented reality is constructed if, for example, the user can operate various devices, e.g., digital home electric appliances, personal computers, etc., and confirm their operation through the user interface of a portable terminal which provides a console panel environment similar to the console panels of those devices in a ubiquitous computing network environment, while the user is not actually touching any control switches and buttons of the devices.

Heretofore, in order for a portable terminal to be able to serve as a terminal for operating various devices, the portable terminal is required to have a high-precision GPS system for recognizing the physical position thereof and also to have dedicated interfaces. Furthermore, even if a portable terminal can control some functions of other devices, interfaces similar to the interfaces peculiar to those functions are not available to the portable terminal. Therefore, controlling those functions through the portable terminal does not make the user feel intuitive and fails to give the user an augmented reality environment.

### SUMMARY OF THE INVENTION

It is an object of the present invention to provide a device control system for allowing the user to control functions of various devices through a terminal owned by the user, as if the user performs those functions through the console panels of those devices.

To achieve the above object, there is provided in accordance with the present invention a device control system for allowing a terminal to control the functions of another device. The device control system includes an information processing terminal for controlling the functions of the other device through a user interface thereof, the information processing terminal having a device searcher for sending a search request to search for a device capable of providing control and receiving a search response message including information about functions that can be provided, a control requester for sending a terminal message including coordinate information of a display screen of the user interface and an identifier of the information processing terminal for making a control request, a display controller for displaying on the display screen a search category of control items, the functions that can be provided by the other device, and events in a display mode based on event detail information, and a control request processor for sending a control request message to the other device in response to operation of the events displayed on the display screen. The device control system also includes a control providing device for performing functions thereof according to the control request from the information processing terminal, the control providing device having a search response processor for receiving the search message and returning the search response message, a control request response processor for receiving the terminal message, managing the information processing terminal as a terminal for controlling the control providing device based on the identifier, assigning events controllable by the user to relative positions of coordinates recognized from the coordinate information, thereby generating the event detail information, and sending the event detail information, and a function executing unit for receiving the control request message and executing a function corresponding thereto.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagrams showing the principles of a device control system according to the present invention;

FIGS. 2 and 3 are diagrams showing an operation sequence of the device control system;

FIG. 4 is a diagram showing a format of a search message;

FIG. 5 is a diagram showing a format of a search response message;

FIG. 6 is a diagram showing a format of a terminal message;

FIG. 7 is a diagram showing an example of displayed image;

FIG. 8 is a diagram showing a format of a control request message;

FIG. 9 is a diagram showing the manner in which a captured image is pasted and events are displayed;

FIG. 10 is a diagram showing the manner in which a captured image is pasted and events are displayed;

FIG. 11 is a diagram showing the manner in which displayed events are angularly moved through an angle;

FIG. 12 is a diagram showing the manner in which events are divided into a plurality of images and displayed;

FIG. 13 is a diagram showing the relationship between divided images and the numbers of clicks;

FIG. 14 is a flowchart of an operational sequence from the display of a search category to the transmission of a search message;

FIG. 15 is a flowchart of an operational sequence from the reception of a search message to the transmission of a search response message;

FIG. 16 is a diagram showing a process of matching a search message and a device information table;

FIG. 17 is a flowchart of an operational sequence from the transmission of a search response message to the display of a provided function;

FIG. 18 is a flowchart of an operational sequence from the display of a provided function to the transmission of a terminal message;

FIG. 19 is a flowchart of an operational sequence from the reception of a terminal message to the transmission of event detail information;

FIG. 20 is a flowchart of an operational sequence of a connection management process performed by a connected state manager for an information processing terminal;

FIG. 21 is a flowchart of an operational sequence of a display control process for an event;

FIG. 22 is a flowchart of an operational sequence of a display control process in each display mode;

FIG. 23 is a flowchart of an operational sequence of an image pasting process performed by a display controller and an image capturing unit;

FIG. 24 is a flowchart of an operational sequence of a control request processor in an accumulation mode;

FIG. 25 is a flowchart of an operational sequence of a function executing unit;

FIG. 26 is a diagram showing a format of event detail information;

FIG. 27 is a diagram showing a format of event detail information;

FIG. 28 is a diagram showing a format of event detail information;

FIG. 29 is a diagram showing a format of event detail information;

FIG. 30 is a diagram showing a specific example of event detail information;

FIG. 31 is a diagram showing a device control system for performing relaying operation;

FIGS. 32 and 33 are flowcharts of an operational sequence of a modified device control system;

FIG. 34 is a diagram showing a format of a search message arranged in a Beacon frame;

FIG. 35 is a diagram showing a device control system for controlling elevating and lowering movement of an elevator;

FIGS. 36 and 37 are flowcharts of an operational sequence of the device control system for performing elevator control;

FIG. 38 is a diagram showing a device control system for sending an alarm message;

FIG. 39 is a flowchart of an operational sequence of the device control system for sending an alarm message;

FIG. 40 is a diagram showing a device control system for controlling a remote controller;

FIGS. 41 and 42 are flowcharts of an operational sequence of the device control system for controlling a remote controller;

FIG. 43 is a diagram showing a device control system for controlling a bank ATM; and

FIGS. 44 and 45 are flowcharts of an operational sequence of the device control system for controlling a bank ATM.

### DESCRIPTIONM OF THE PREFERRED EMBODIMENTS

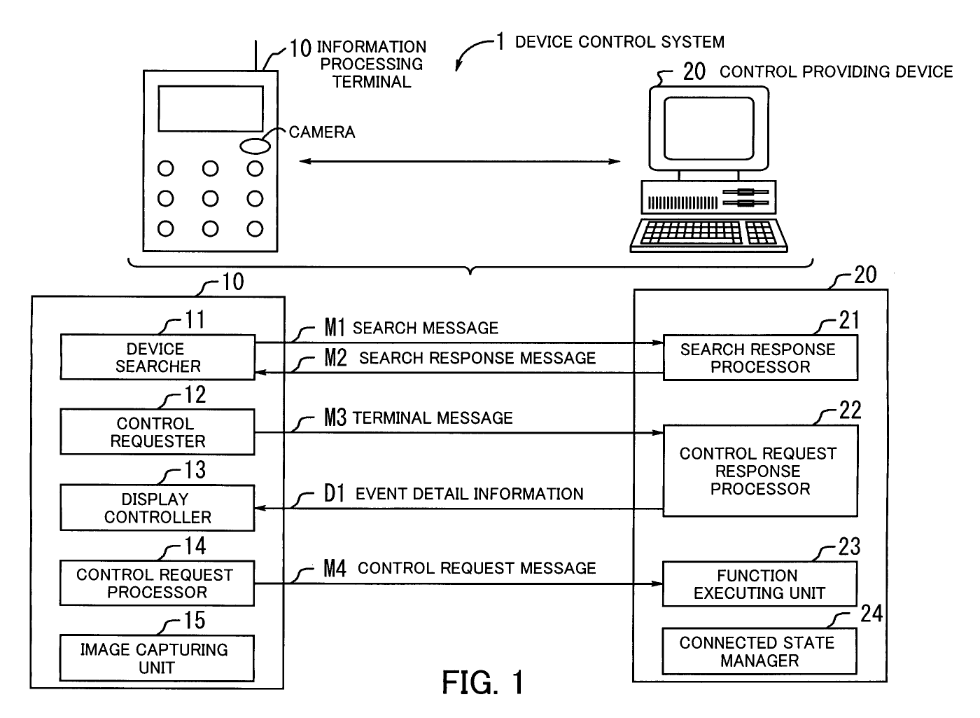

Embodiments of the present invention will be described below with reference to the accompanying drawings. FIG. 1 shows the principles of a device control system according to the present invention.

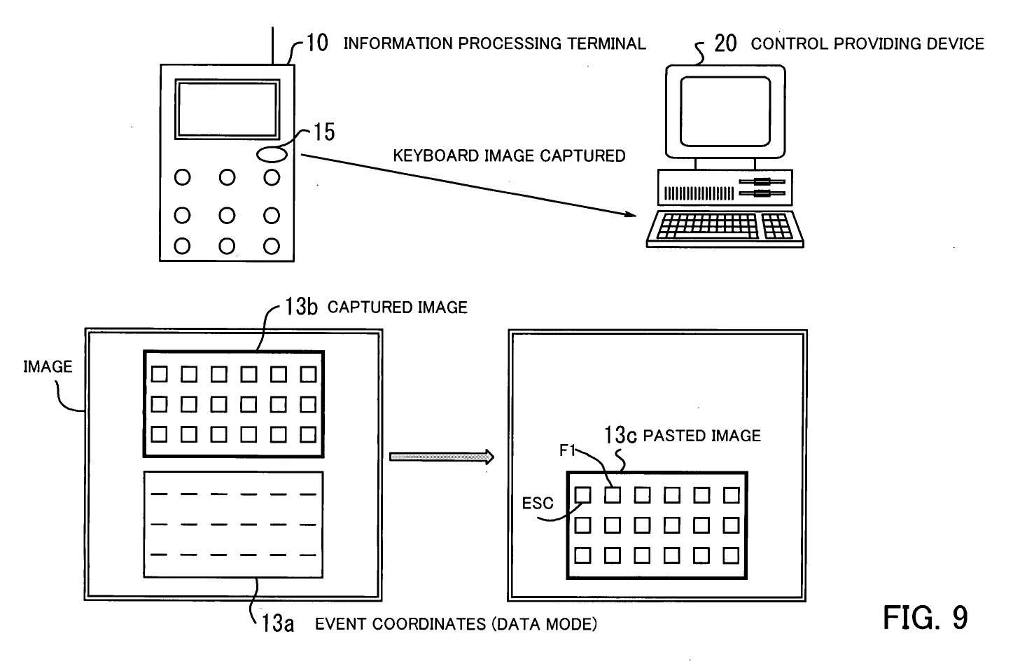

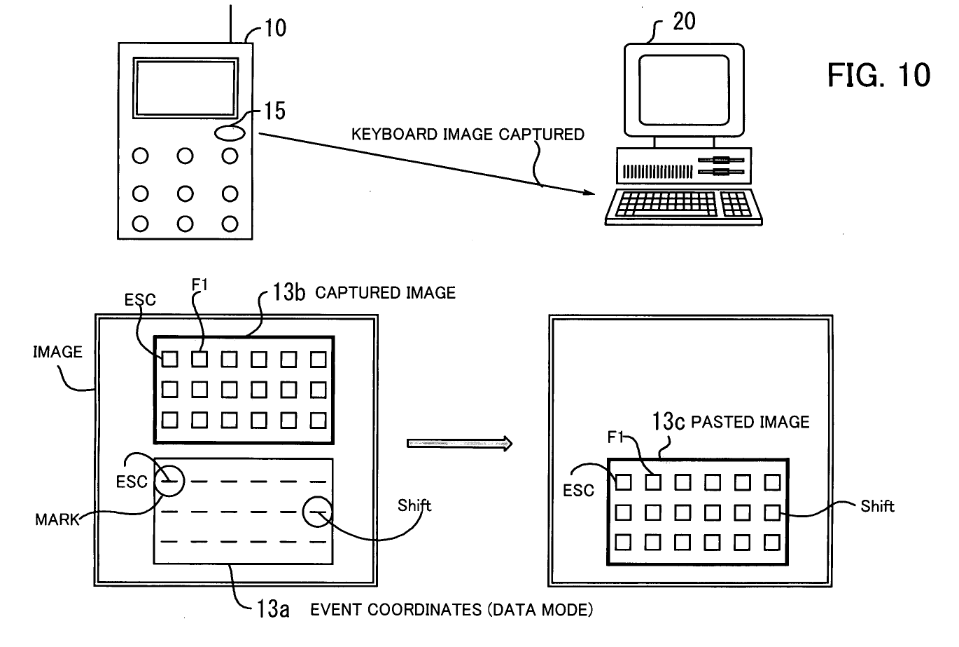

As shown in FIG. 1, the device control system, generally denoted by 1, comprises an information processing terminal 10, e.g., a cellular phone combined with a camera, as a user's terminal, and a control providing device 20, e.g., a personal computer, as another device. The device control system 1 allows the information processing terminal 10 to control the control providing device 20 through an interface environment similar to the user interface of the control providing device 20. For example, the interface environment constitutes an image of the keyboard of a personal computer which is displayed on the screen of a cellular phone, and the user of the cellular phone touches displayed keys in the image to operate the personal computer (this example will be described later on with reference to FIGS. 9 and 10).

The information processing terminal 10 comprises a device searcher 11, a control requester 12, a display controller 13, a control request processor 14, and an image capturing unit 15.

The device searcher 11 sends a search message M1 for searching for a device capable of providing control to the control providing device 20, and receives a search response message M2 including a function that can be provided from the control providing device 20.

The control requester 12 sends a terminal message M3 including the coordinate information of the display screen of a user interface and the ID of the information processing terminal 10 to the control providing device 20, requesting the control providing device 20 to provide control.

The display controller 13 displays a search category of control items on the display screen, and also displays the functions provided by the other device on the display screen. The display controller 13 further displays on the display screen an event corresponding to a display mode based on event detail information D1 received from the control providing device 20.

The control request processor 14 sends a control request message M4 to the control providing device 20 when the user operates on the event displayed on the display screen. The image capturing unit 15 provides a camera function, and captures an image and stores the captured image.

The control providing device 20 comprises a search response processor 21, a control request response processor 22, a function executing unit 23, and a connected state manager 24.

The search response processor 21 receives a search message M1 from the information processing terminal 10 and returns a search response message M2 to the information processing terminal 10.

The control request response processor 22 receives a terminal message M3 from the information processing terminal 10 and manages the terminal which controls control providing device 20 based on the ID of the information processing terminal 10 which is included in the terminal message M3. The control request response processor 22 also assigns events that are controllable by input actions of the user to relative coordinate positions which are recognized from the coordinate information in the terminal message M3, generates event detail information D1, and sends the event detail information D1 to the information processing terminal 10.

The function executing unit 23 receives a control request message M4 from the information processing terminal 10, and executes the corresponding function.

The connected state manager 24 manages a connected state of the control providing device 20 with respect to the information processing terminal 10. Specifically, the connected state manager 24 periodically monitors the intensity of a radio wave transmitted from the information processing terminal 10. If the monitored intensity of the radio wave is lower than a threshold level, then the connected state manager 24 deletes the information processing terminal 10 from managed terminals. If the monitored intensity of the radio wave exceeds the threshold level, then the connected state manager 24 manages the information processing terminal 10 as a terminal for operating the control providing device 20 by monitoring the information processing terminal 10 based on a timer. If the control providing device 20 is not accessed from the information processing terminal 10 within an effective time set by the timer, then the connected state manager 24 deletes the information processing terminal 10 from managed terminals.

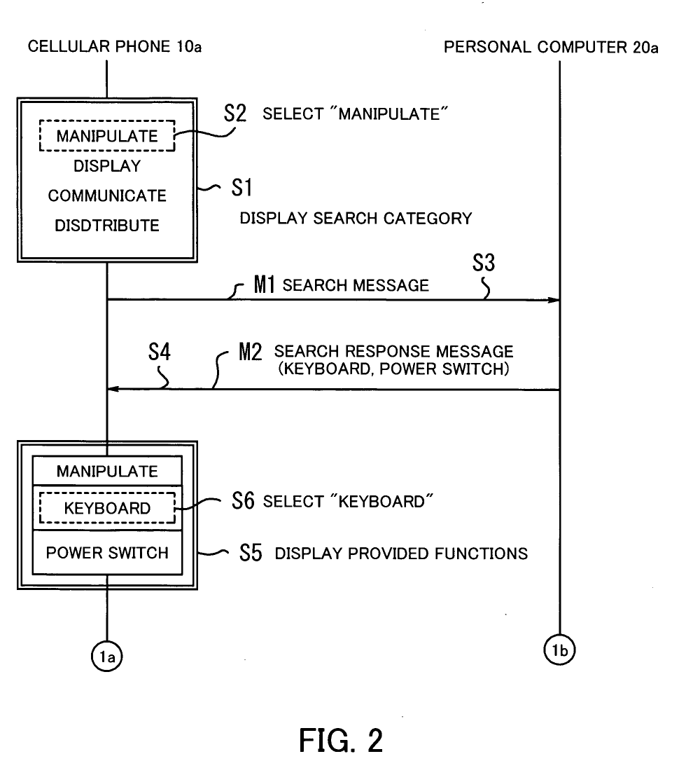

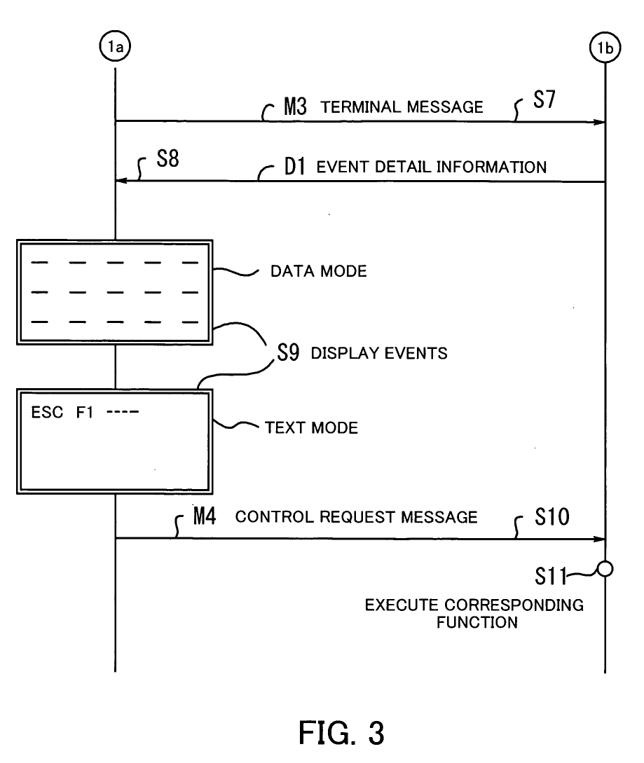

General operation of the device control system 1 will be described below. It is assumed that the information processing terminal 10 is a cellular phone 10a with a camera and the control providing device 20 is a personal computer 20a (see FIGS. 2 and 3).

FIGS. 2 and 3 show an operation sequence of the device control system 1 shown in FIG. 1.

(S1) The display controller 13 of the cellular phone 10a displays a search category of control items for the personal computer 20a on the display screen of the user interface of the cellular phone 10a. For example, if the cellular phone 10a can control the personal computer 20a in four control modes, i.e., a control mode for “manipulating” the personal computer 20a, a control mode for “displaying” certain information on the personal computer 20a, a control mode for “communicating” with the personal computer 20a, and a control mode for “distributing” certain information from the personal computer 20a, then the display controller 13 displays “MANIPULATE,” “DISPLAY,” “COMMUNICATE,” and “DISTRIBUTE” as the control items as the search category on the display screen of the user interface of the cellular phone 10a.

(S2) The user selects “MANIPULATE,” for example, from the search category.

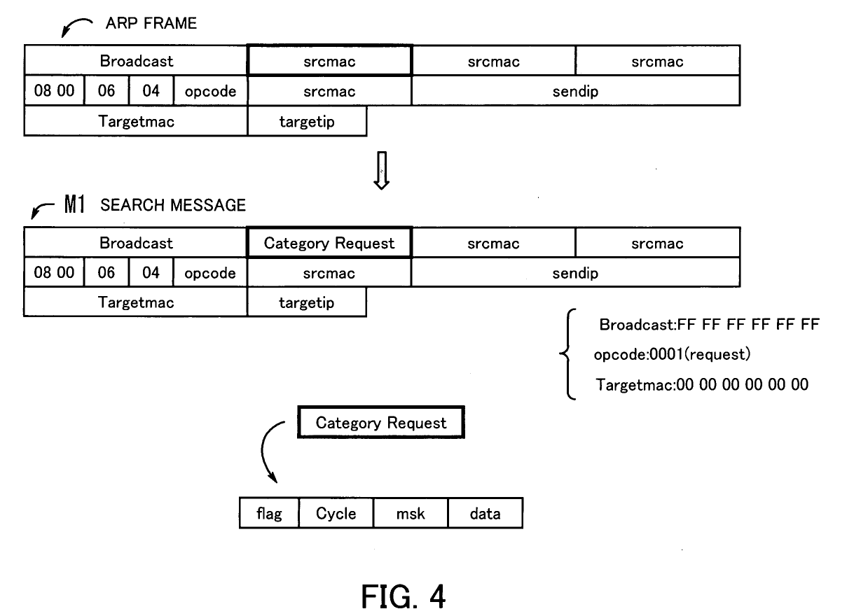

(S3) The device searcher 11 of the cellular phone 10a generates a search message M1 including a Category Request (“MANIPULATE” request), and sends the search message M1 to the personal computer 20a. A detailed format of the search message M1 will be described later with reference to FIG. 4.

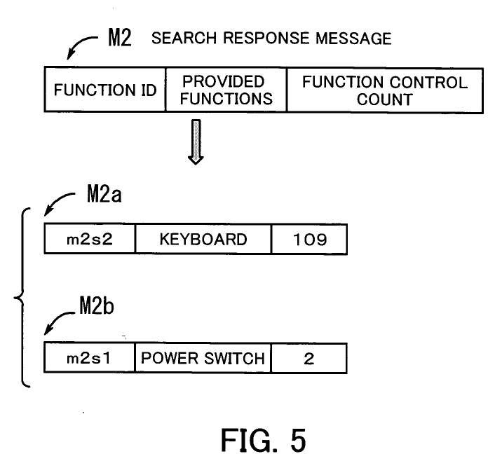

(S4) When the search response processor 21 of the personal computer 20a receives the search message M1, since the Category Request is the “MANIPULATE” request, the search response processor 21 recognizes that the cellular phone 10a is to manipulate the personal computer 20a. If the keyboard and the power switch of the personal computer 20a are available as functions that can be manipulated by cellular phone 10a, then the search response processor 21 adds information representing the keyboard and the power switch as functions that can be provided, to a search response message M2, and sends the search response message M2 to the cellular phone 10a. A detailed format of the search response message M2 will he described later with reference to FIG. 5.

(S5) The cellular phone 10a receives the search response message M2, and the display controller 13 displays “KEYBOARD” and “POWER SWITCH” on the display screen as the functions provided by the personal computer 20a which correspond to “MANIPULATE.”

(S6) The user selects “KEYBOARD,” for example.

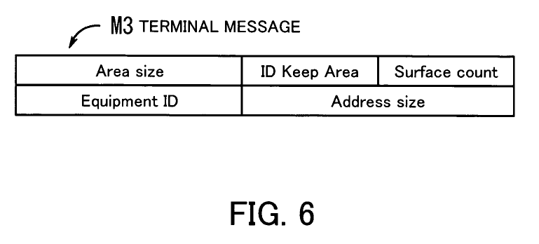

(S7) The control requester 12 of the cellular phone 10a adds the coordinate information of the display screen of the user interface, i.e., information representing the numbers of pixels in vertical and horizontal directions of the display screen, and the ID of the cellular phone 10a, to a terminal message M3, and sends the terminal message M3 to the personal computer 20a to make a control request. A detailed format of the terminal message M3 will be described later with reference to FIG. 6.

(S8) The control request response processor 22 of the personal computer 20a receives the terminal message M3, and manages the information processing terminal 10 as a terminal for operating the personal computer 20a, using the ID of the cellular phone 10a. The control request response processor 22 also recognizes coordinates of the display screen of the user interface of the cellular phone 10a from the coordinate information contained in the terminal message M3, assigns events of the keyboard to relative positions of the coordinates to generate event detail information D1, and sends the event detail information D1 to the cellular phone 10a.

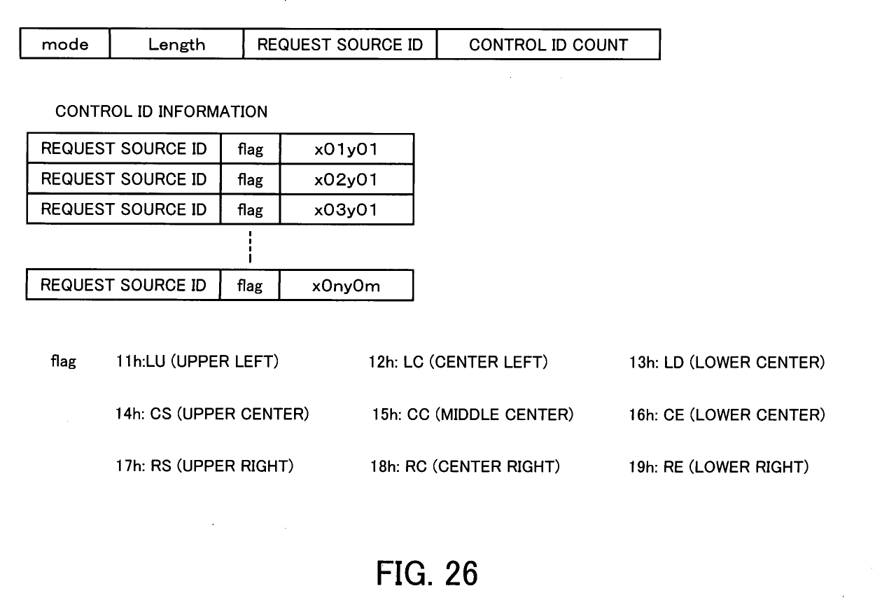

An event refers to an individual function that is provided by the control providing device 20 when the information processing terminal 10 controls the control providing device 20. For example, events of a keyboard correspond to respective keys of the keyboard. Specifically, control keys such as ESC, F1, numerical keys such as 0 through 9, and letter keys such as A through Z of a keyboard serve as respective events of the keyboard. The event detail information D1 is information representing a combination of these functions that are provided by the control providing device 20, in association with the identifier of the information processing terminal 10. A detailed format of the event detail information D1 will be described later with reference to FIGS. 26 through 29.

(S9) The display controller 13 receives the event detail information D1, and displays the events in a display mode based on the event detail information D1 on the display screen. For example, display modes shown in FIG. 3 are a data mode and a text mode. The data mode is a mode for displaying marks (highlighted) corresponding to respective events at respective coordinates on the display screen. The text mode is a mode for displaying texts (names such as ESC, F1, etc.) of events on the display screen. Events are associated with respective IDs (hereinafter referred to as control IDs), and managed by those control IDs.

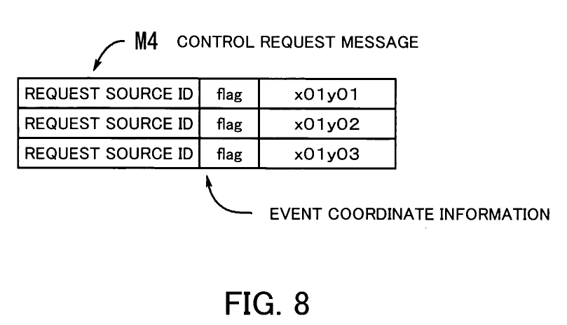

(S10) The user operates on one or some of the events displayed on the display screen of the cellular phone 10a. The control request processor 14 of the cellular phone 10a sends a control request message M4 for the corresponding key or keys to the personal computer 20a. For example, when the user touches the ESC key and the F1 key displayed on the display screen, the control request processor 14 sends a control request message M4 for the ESC key and the F1 key to the personal computer 20a. A detailed format of the control request message M4 will be described later with reference to FIG. 8.

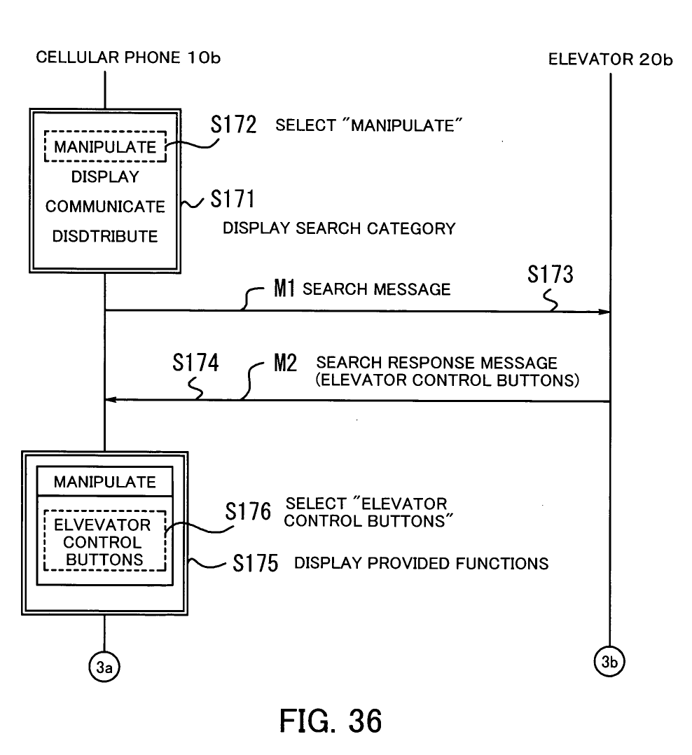

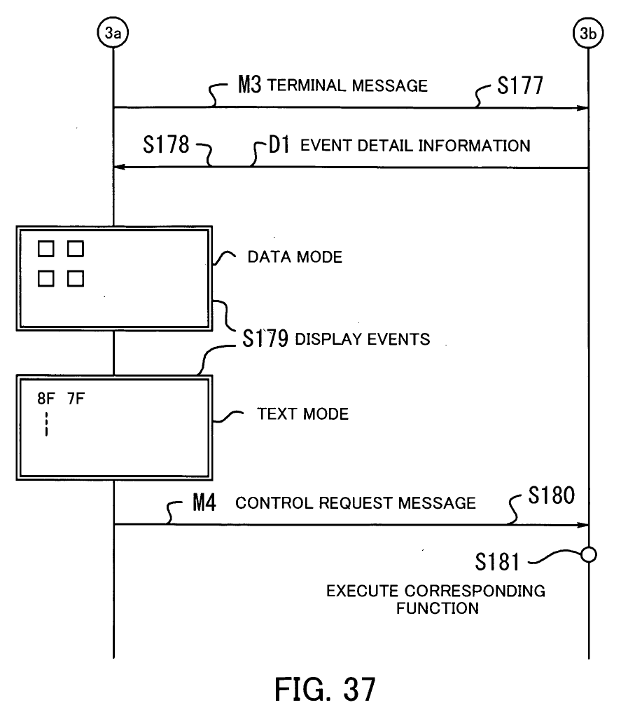

(S11) The function executing unit 23 of the personal computer 20a receives the control request message M4 sent from the cellular phone 10a, and executes the corresponding function. In the above example, the function executing unit 23 executes the respective functions of the ESC key and the F1 key. The function executing unit 23 can receive as many control requests from the information processing terminal 10 as a preset number, and exclusively execute only as many functions as the preset number. An example of such operation will be described later with reference to FIGS. 36 and 37.

In this manner, the device control system 1 allows the user to control the personal computer 20a and confirm its operation in an environment (the data mode and the text mode in the above example) similar to the keyboard of the personal computer 20a, using the user interface of the cellular phone 10a, without actually touching the keyboard of the personal computer 20a.

Heretofore, in order for a portable terminal to be able to serve as a terminal for operating various devices, the portable terminal is required to have a high-precision GPS system for recognizing the physical position thereof and also to have dedicated interfaces, as described above. The device control system 1, however, does not need such a GPS system and dedicated interfaces, and can operate controllable functions in an interface environment similar to the user interfaces of those functions. Therefore, the user can operate other devices intuitively using its own terminal in an augmented reality environment.

The formats of the various messages will be described below. FIG. 4 shows a format of the search message M1. The device searcher 11 generates a search message M1 using an ARP frame where ARP stands for Address Resolution Protocol which is a protocol used to determine a MAC address from an IP address on a TCP/IP network.

The device searcher 11 inserts the information of a Category Request into an srcmac field in the format of the ARP frame. The category request comprises fields of flag, Cycle, msk, and data.

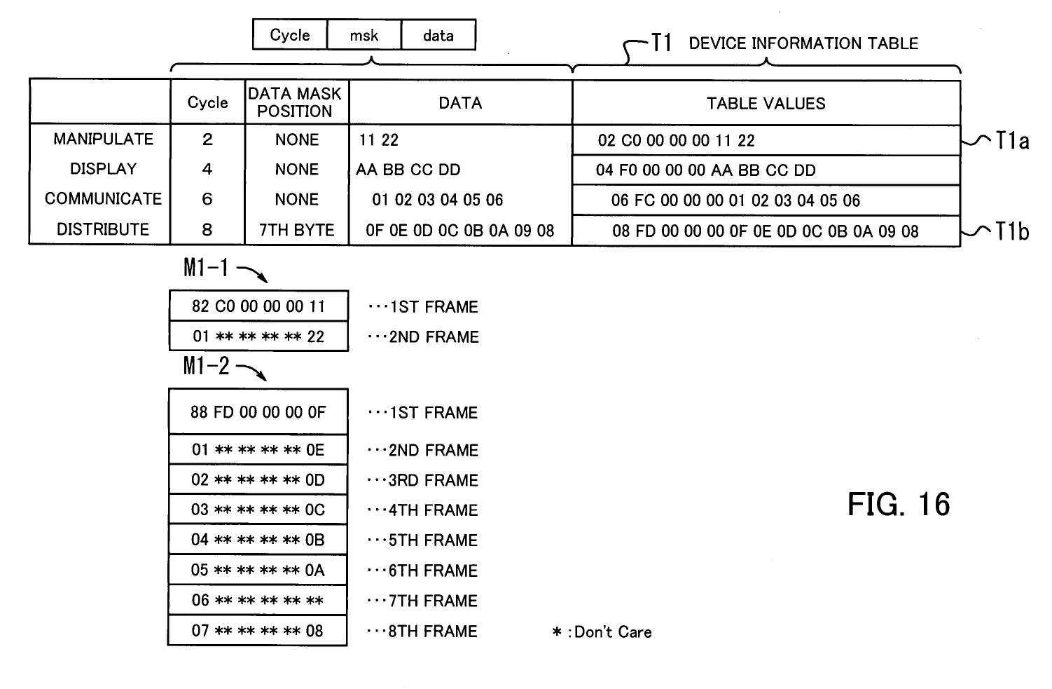

The flag (1 bit) represents a data frame when it is 0, and represents a synchronous frame when it is 1. When the information of a Category Request is inserted, the flag is set to 1. When the flag is 1, the Cycle represents the number of valid frames. If the msk is 1, then the corresponding frame is valid, and if the msk is 0, then the corresponding frame is invalid. The data represents 8-bit data of the frame (it is possible to indicate an IP address in this area). Examples of these fields will be described later with reference to FIG. 16.

FIG. 5 shows a format of the search response message M2. The search response message M2 is made up of fields representing a function ID, a provided function, and a function control count. The function ID refers to the ID of a function provided by the control providing device 20. The provided function refers to the name of a function provided by the control providing device 20. The function control count refers to the number of individual functions.

For example, a search response message M2a indicates that the provided function is a keyboard, the ID of the keyboard is m2s2, and the function control count represents 109 keys, and a search response message M2b indicates that the provided function is a power switch, the ID of the power switch is m2s1, and the function control count represents 2 states (ON/OFF).

FIG. 6 shows a format of the terminal message M3. The terminal message M3 includes fields of Area size, ID Keep Area, Surface count, Equipment ID, and Address size.

The Area size represents the information of a pixel area (horizontal and vertical sizes (the number of pixels)) available as an actual display screen. The ID Keep Area represents a pixel area of horizontal and vertical dimensions required to display one control ID (one event). The Surface count represents the number of Area sizes (it can independently indicate the number of Area sizes in the horizontal direction and the number of Area sizes in the vertical direction). The Equipment ID represents the ID of the information processing terminal 10. The Address size represents the number of control IDs that can be accepted by the information processing terminal 10.

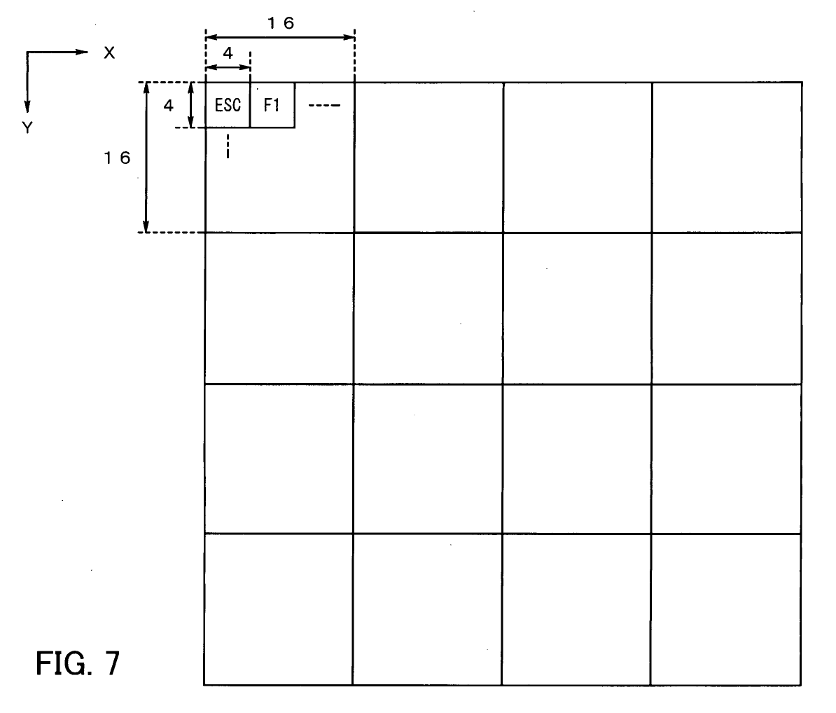

FIG. 7 shows an example of displayed image. Specifically, FIG. 7 shows a displayed image defined by the coordinate information of the terminal message M3. For example, if Area size=0f0f, then it represents an area made up of pixels along the horizontal axis (X-axis) x pixels along vertical axis (Y-axis)=16×16 pixels=256 pixels. If ID Keep Area=0404, then it represents an area having a size of 4×4 pixels assigned to one event. If Surface count=0404, then it indicates that there are four areas defined by the Area size along the horizontal axis and four areas defined by the Area size along the vertical axis.

FIG. 8 shows a format of the control request message M4. The control request message M4 includes fields of request source ID, flag, and event coordinate information. The request source ID represents the ID of the information processing terminal 10. The flag is 1 if a control request is made, and is 0 if a control request is not made. The event coordinate information represents the coordinate information of an event that is displayed on the display screen.

If the coordinate information of the ESC key is x01y01, and the control request message M4 with the request source ID=3ffe fffe 0000 0000, flag=1, and the control ID=the event detail information=x01y01 is sent from the information processing terminal 10 to the control providing device 20, then the control providing device 20 recognizes that a control request for the ESC having a coordinate position of x01y01 is set from the information processing terminal 10 having an ID of 3ffe fffe 0000 0000.

A display mode for events on the display screen of the information processing terminal 10 will be described below. FIG. 9 shows the manner in which a captured image is pasted and events are displayed. The information processing terminal 10 has a camera function (image capturing unit 15). The information processing terminal 10 captures an image of the keyboard of the control providing device 20, and acquires the captured image.

The display controller 13 pastes a captured keyboard image 13b onto event coordinates 13a that are displayed on the display screen in the data mode, generating a pasted image 13c. If the captured keyboard image 13b is positionally displaced from the event coordinates 13a, then the captured keyboard image 13b may be positionally shifted into alignment with the event coordinates 13a. The user then touches (clicks on) desired keys in the pasted image 13c to control operation of the control providing device 20.

FIG. 10 shows the manner in which a captured image is pasted and events are displayed. In FIG. 9, the captured keyboard image 13b is positionally adjusted into alignment with the event coordinates 13a. In FIG. 10, certain ones of the event coordinates 13a are associated with marks, and the user captures an image of the keyboard and acquires the captured image while keeping the marks in positional alignment with the corresponding positions on the keyboard. Therefore, the captured keyboard image 13b is automatically pasted onto the event coordinates 13a without positional misalignments.

Specifically, the control request response processor 22 sends event detail information D1, which includes the positional information of an event (e.g., information indicating that the ESC key is in an upper left area of the keyboard), to the information processing terminal 10. The display controller 13 receives the event detail information D1 and applies a mark to the coordinate, e.g., changes the color of that area, on the display screen based on the positional information.

If the ESC key and the Shift key are marked, then the user positionally aligns the marks with the ESC key and the Shift key on the actual keyboard, and then releases the shutter of the camera to capture an image of the keyboard. The display controller 13 then automatically pastes the captured keyboard image 13b onto the event coordinates 13a with the ESC key and the Shift key marked, thereby generating the pasted image 13c.

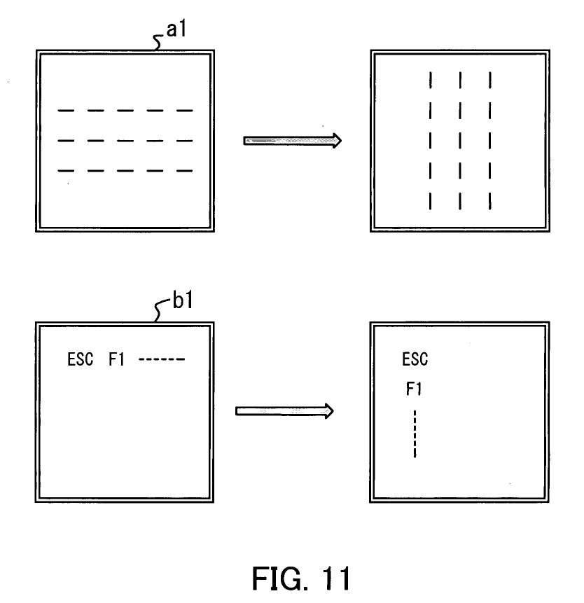

FIG. 11 shows the manner in which displayed events are angularly moved through an angle. The display controller 13 can display an event at different angles changed by a command from the user. In FIG. 11, displayed events a1 in the data mode are angularly moved through an angle of 90° from a horizontal orientation to a vertical orientation, and display events b1 in the text mode are angularly moved through an angle of 90° from a horizontal orientation to a vertical orientation.

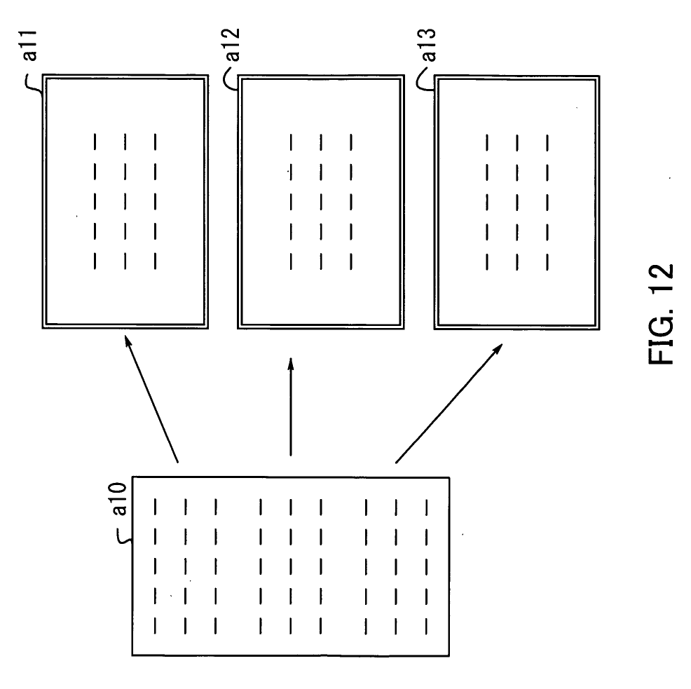

FIG. 12 shows the manner in which events are divided into a plurality of images and displayed. If all events cannot be displayed in one screen image, then they are divided into a plurality of images and displayed. In FIG. 12, displayed events a10 in the data mode are divided vertically into three groups of display events all, a12, a13. When the user touches or clicks on either one of the keys in one of the groups of display events all, a12, a13, the corresponding function is performed.

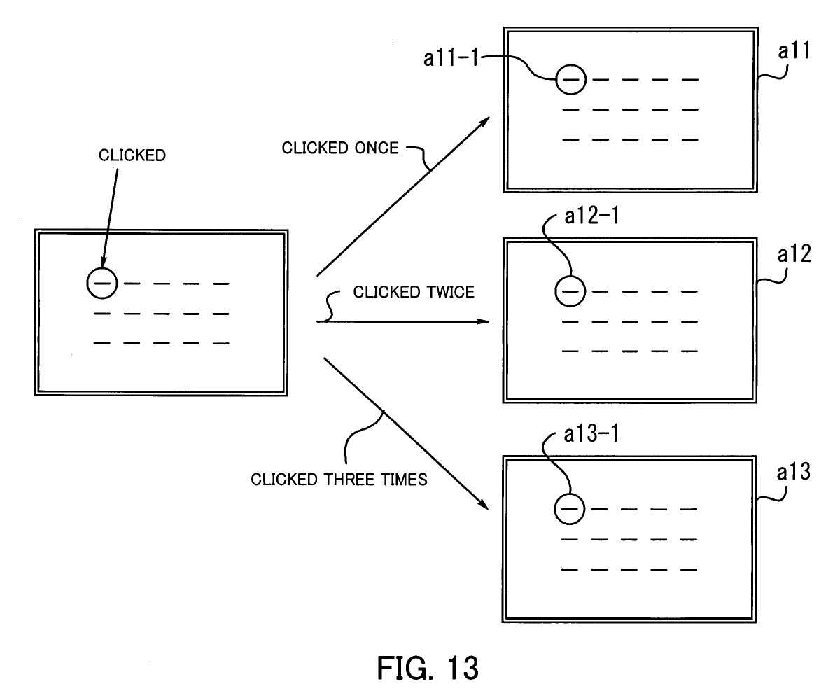

FIG. 13 shows the relationship between divided images and the numbers of clicks. When the display controller 13 divides events into a plurality of images and displays the images, the display controller 13 may associate each of the divided images with the number of clicks given per unit time. This display control mode will hereinafter be referred to as a multi-action mode. It is assumed, for example, that when displayed events are divided into three groups of display events all, a12, a13, the same event coordinates are displayed in each of those groups of display events all, a12, a13.

If the user clicks once on a certain event in the initial image, it is assumed that the user gives a command to a certain event a11-1 in the group of displayed events all. If the user clicks twice on a certain event in the initial image, it is assumed that the user gives a command to a certain event a12-1 in the group of displayed events a12. If the user clicks three times on a certain event in the initial image, it is assumed that the user gives a command to a certain event a13-1 in the group of displayed events a13. The events a11-1, a12-1, a13-1 are positioned at the same coordinates in the corresponding groups of display events, and correspond to the divided images or displayed events depending on the number of clicks. The multi-action mode makes it possible to improve the ease of controlling operation within small images.

Operation of the components of the information processing terminal 10 and the control providing device 20 will be described below.

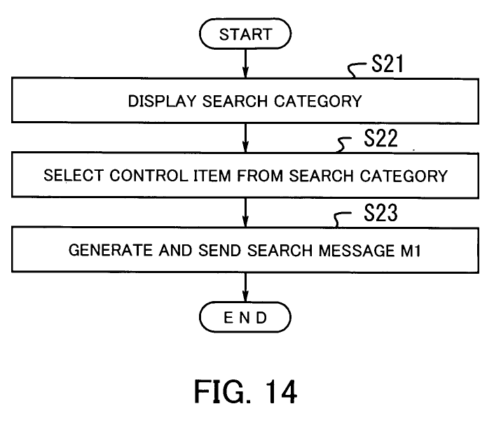

FIG. 14 shows an operational sequence from the display of a search category to the transmission of a search message M1.

(S21) The display controller 13 displays a search category.

(S22) The user selects a certain control item from the search category.

(S23) The device searcher 11 generates and sends a search message M1.

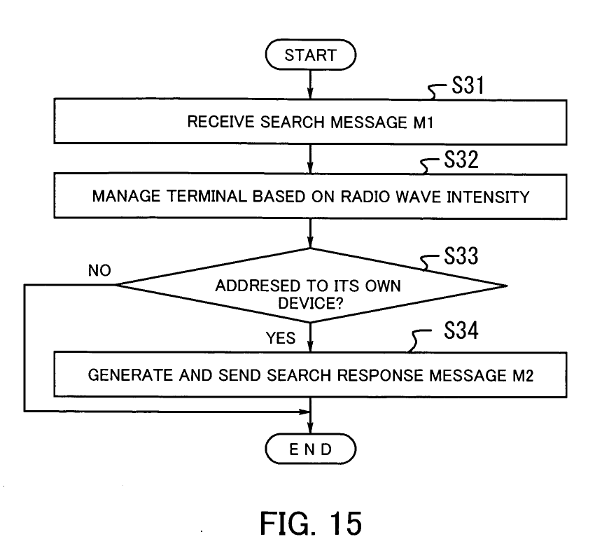

FIG. 15 shows an operational sequence from the reception of a search message M1 to the transmission of a search response message M2.

(S31) The search response processor 21 receives a search message M1.

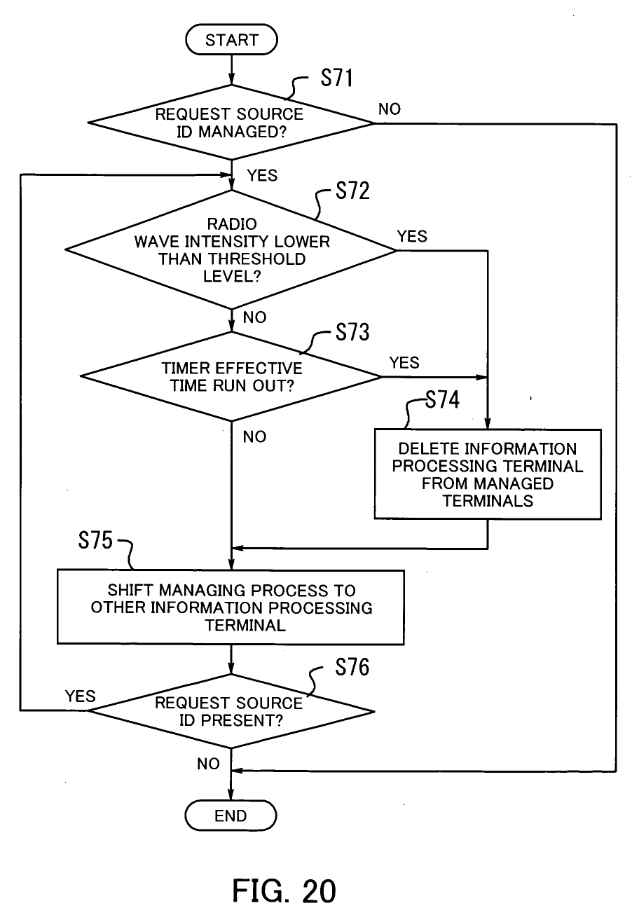

(S32) The connected state manager 24 manages the intensity of a radio wave transmitted from the information processing terminal 10, as will be described later with reference to FIG. 20.

(S33) The search response processor 21 performs a process of matching the contents of the search message M1 and the contents of a device information table managed by the search response processor 21 itself, as will be described later with reference to FIG. 16, and determines whether the search message M1 is addressed to the control providing device 20 or not. If the search message M1 is not addressed to the control providing device 20, then the operational sequence is put to an end. If the search message M1 is addressed to the control providing device 20, then control goes to step S34.

(S34) The search response processor 21 generates and sends a search response message M2 to the information processing terminal 10.

FIG. 16 shows a process of matching a search message M1 and a device information table. The search response processor 21 manages values corresponding to the fields of Cycle, msk, and data of the Category Request of the control items “MANIPULATE,” “DISPLAY,” “COMMUNICATE,” and “DISTRIBUTE” in the search message M1, as the values of the device information table T1.

In the Category Request of “MANIPULATE,” the values of the Cycle=2, the data mask position=none, and the data=11, 22 are defined. The data value is given as a hexadecimal representation, and 1 byte corresponds to 1 frame. Since the Cycle is 2, the first frame includes the data 11, and the second frame includes the data 22.

The table value of the device information table T1 which corresponds to the above Category Request is given as 02 C0 00 00 00 11 22 where 02 corresponds to the Cycle and C0 00 00 00 to the msk indicating a valid portion of the data. If the msk is 1, then the corresponding data is valid, and if the msk is 0, and then the corresponding data is invalid. C0 00 00 00 indicates that of 32 frames, 2 frames contain data (C0 00 00 00 comprises 32 bits, with 1 bit corresponding to 1 frame. Since C=1100, it indicates that the first frame and the second frame are valid). 11 22 corresponds to data.

In the Category Request of “DISTRIBUTE,” the values of the Cycle=8, the data mask position=7th byte, and the data=0F 0E 0D 0C 0B 0A 09 08 are defined. It is seen that each of 8 frames contains the data of 0E 0D 0C 0B 0A 09 08.

The table value of the device information table T1 which corresponds to the above Category Request is given as 08 FD 00 00 00 0F 0E 0D 0C 0B 0A 09 08 where 08 corresponds to the Cycle and FD 00 00 00 to the msk indicating a valid portion of the data. If the msk is 1, then the corresponding data is valid, and if the msk is 0, and then the corresponding data is invalid. Since FD=1111 1101 with respect to FD 00 00 00, it indicates that the first through eighth frames contain data and the seventh frame is invalid. 0F 0E 0D 0C 0B 0A 09 08 correspond to data, and each of the first through eighth frames contains 0F 0E 0D 0C 0B 0A 09 08.

If the search response processor 21 receives a search message M1-1 shown in FIG. 16, then since it matches table contents T1a of the device information table T1, the search response processor 21 recognizes that the information processing terminal 10 is to “MANIPULATE” the control providing device 20 (if the keyboard and the power switch are to be “MANIPULATED,” then the search response processor 21 returns search response messages M2a, M2b shown in FIG. 5). 8 of 82 at the leading end of the search message M1-1 represents flag=1 since 8=1000.

If the search response processor 21 receives a search message M1-2 shown in FIG. 16, then since it matches table contents T1b of the device information table T1, the search response processor 21 recognizes that the information processing terminal 10 is to “DISTRIBUTE” certain information from the control providing device 20.

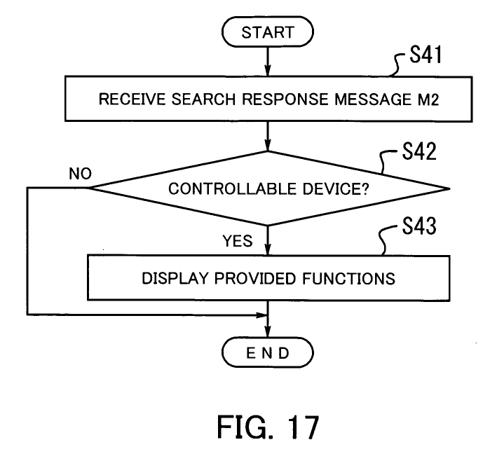

FIG. 17 shows an operational sequence from the transmission of a search response message M2 to the display of a provided function.

(S41) The device searcher 11 receives a search response message M2.

(S42) The device searcher 11 determines whether there is a controllable control providing device 20 or not. If there is no controllable control providing device 20, then the operational sequence is put to an end. If there is a controllable control providing device 20, then control goes to step S43.

(S43) The display controller 13 displays provided functions included in the search response message M2.

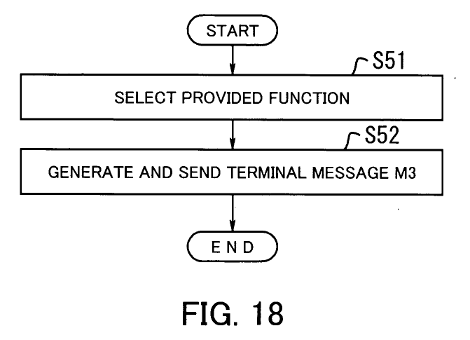

FIG. 18 shows an operational sequence from the display of a provided function to the transmission of a terminal message M3.

(S51) The user selects a function from the displayed the provided functions.

(S52) The control requester 12 generates and sends a terminal message M3.

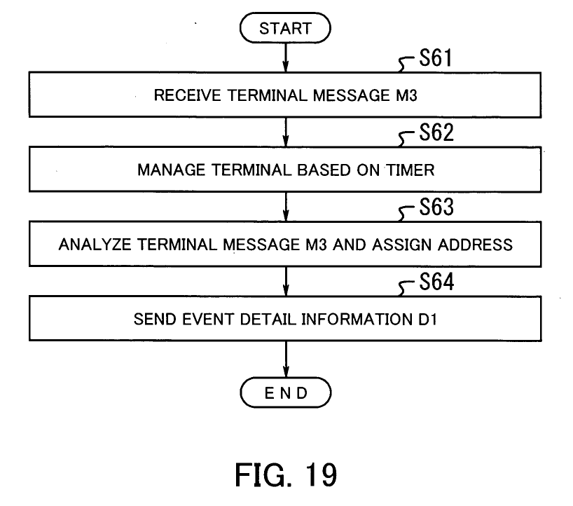

FIG. 19 shows an operational sequence from the reception of a terminal message M3 to the transmission of event detail information D1.

(S61) The control request response processor 22 receives a terminal message M3.

(S62) The connected state manager 24 manages the information processing terminal 10 by monitoring same based on a timer, as will be described later with reference to FIG. 20.

(S63) The control request response processor 22 analyzes the terminal message M3 and assigns an address to the information processing terminal 10.

(S64) The control request response processor 22 sends event detail information D1 to the information processing terminal 10.

FIG. 20 shows an operational sequence of a connection management process performed by the connected state manager 24 for the information processing terminal 10.

(S71) The connected state manager 24 determines whether the request source ID (the ID of the information processing terminal 10) has been managed or not. If the request source ID has been managed, then control goes to step S72. If the request source ID has not been managed, then the operational sequence is ended.

(S72) The connected state manager 24 determines whether the intensity of the radio wave from the requesting terminal is smaller than a preset threshold level or not to confirm the connected state for each request source ID. If the intensity of the radio wave is smaller than the preset threshold level, then control goes to step S74. If the intensity of the radio wave is in excess of the preset threshold level, then control goes to step S73.

(S73) The connected state manager 24 determines whether an effective time set by a timer has run out or not to confirm the connected state for each request source ID. If the effective time has run out, then control goes to step S74. If the effective time has not run out, then control goes to step S75.

(S74) The connected state manager 24 deletes the corresponding information processing terminal 10 as a managed object (and also deletes the control ID of an event requested by the corresponding information processing terminal 10).

(S75) The connected state manager 24 regards the corresponding information processing terminal 10 as being connected to the control providing device 20, and shifts its managing process to another information processing terminal 10 that is to be managed for its connection.

(S76) If there is no request source ID to be confirmed for its connection, i.e., if all request source IDs have been confirmed for their connected states, then the operational sequence is put to an end. Otherwise, control returns to step S71.

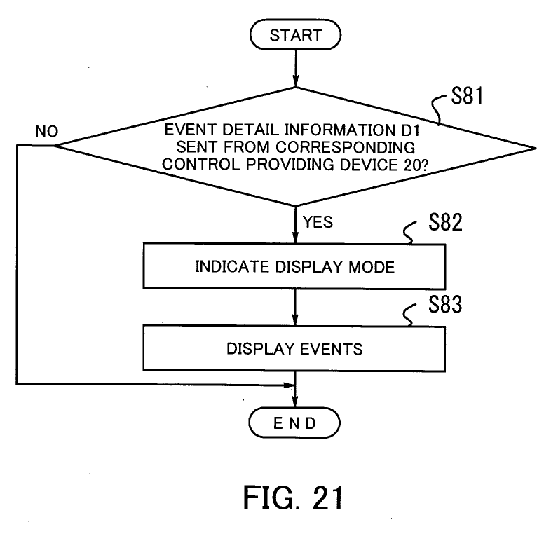

FIG. 21 shows an operational sequence of a display control process for an event.

(S81) The display controller 13 determines whether it has received event detail information D1 from the corresponding control providing device 20 or not. If the display controller 13 has received event detail information D1 from the corresponding control providing device 20, then control goes to step S82. If not, then the operational sequence is ended.

(S82) The user designates a display mode.

(S83) The display controller 13 displays an event according to the display mode.

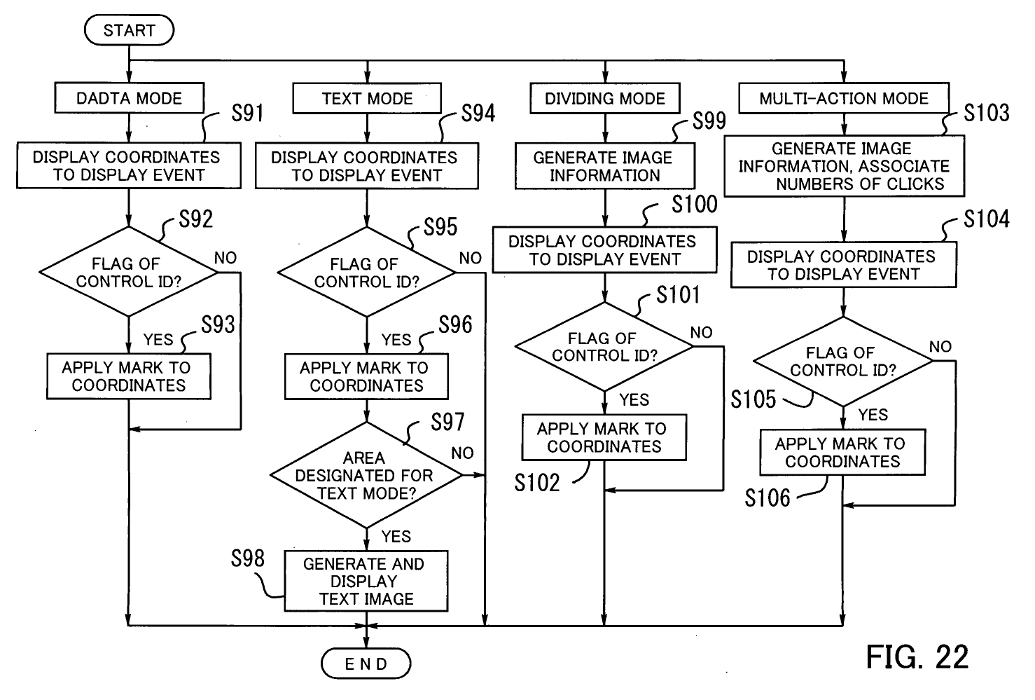

FIG. 22 shows an operational sequence of a display control process in each display mode.

(S91) In the data mode, the display controller 13 displays coordinates at which to display an event.

(S92) The display controller 13 determines whether the flag of a control ID is carried in the event detail information D1 or not. If it is carried, then control goes to step S93. If it is not, then the operational sequence is put to an end.

(S93) The display controller 13 applies a mark to the coordinates of the event.

(S94) In the text mode (in which the image is wholly or partly text), the display controller 13 displays coordinates at which to display an event.

(S95) The display controller 13 determines whether the flag of a control ID is carried in the event detail information D1 or not. If it is carried, then control goes to step S96. If it is not, then the operational sequence is put to an end.

(S96) The display controller 13 applies a mark to the coordinates of the event.

(S97) The display controller 13 determines whether there is an area designated for the text mode or not. If there is an area designated for the text mode, then control goes to step S98. If not, then the operational sequence is put to an end.

(S98) The display controller 13 generates and displays a text image.

(S99) In the dividing mode, the display controller 13 generates image information, i.e., information as to the number of divided images.

(S100) The display controller 13 displays coordinates at which to display an event.

(S101) The display controller 13 determines whether the flag of a control ID is carried in the event detail information D1 or not. If it is carried, then control goes to step S102. If it is not, then the operational sequence is put to an end.

(S102) The display controller 13 applies a mark to the coordinates of the event.

(S103) In the multi-action mode, the display controller 13 generates image information depending on the number of clicks.

(S104) The display controller 13 displays coordinates at which to display an event.

(S105) The display controller 13 determines whether the flag of a control ID is carried in the event detail information D1 or not. If it is carried, then control goes to step S106. If it is not, then the operational sequence is put to an end.

(S106) The display controller 13 applies a mark to the coordinates of the event.

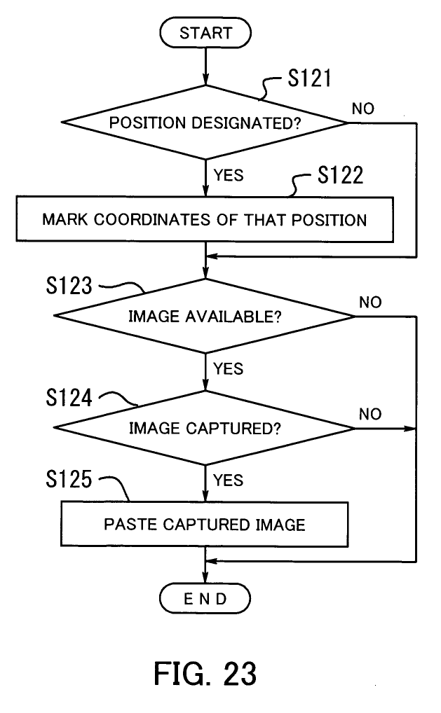

FIG. 23 shows an operational sequence of an image pasting process performed by the display controller 13 and the image capturing unit 15.

(S121) The display controller 13 determines whether a position is designated by the positional information in the event detail information D1 or not. If a position is designated, then control goes to step S122. If not, then control goes to step S123.

(S122) The display controller 13 marks the coordinates of the designated position.

(S123) If there is an available image, then control goes to step S124. If not, then the operational sequence is ended.

(S124) If the image capturing unit 15 captures an image, then control goes to step S125. If not, then the operational sequence is ended.

(S125) The display controller 13 pastes the captured image.

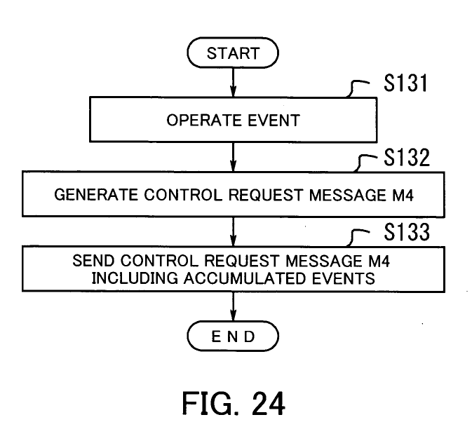

FIG. 24 shows an operational sequence of the control request processor 14 in an accumulation mode.

(S131) The user operates a displayed event.

(S132) The control request processor 14 adds the information of the operated event, generating a control request message M4.

(S133) In response to a control action of the user, the control request processor 14 sends accumulated events altogether on the control request message M4.

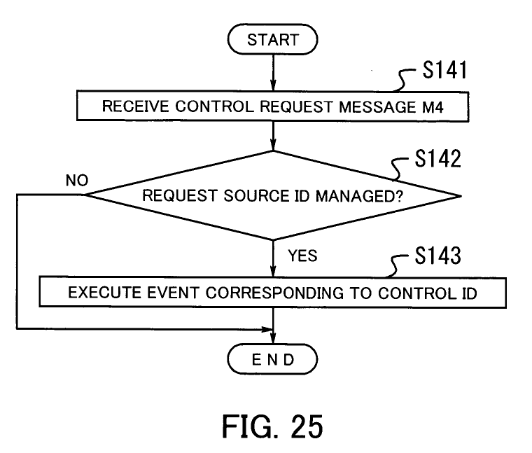

FIG. 25 shows an operational sequence of the function executing unit 23.

(S141) The function executing unit 23 receives a control request message M4.

(S142) The function executing unit 23 determines whether the request source ID has been managed or not. If the request source ID has been managed, then control goes to step S143. If the request source ID has not been managed, then the operational sequence is ended.

(S143) The function executing unit 23 executes a process corresponding to the control ID.

A format of the event detail information D1 will be described below. FIGS. 26 through 29 show a format of the event detail information D1. The event detail information D1 comprises fields of mode, Length, request source ID, control ID number, and control ID information. If the mode is 0, then it indicates the data mode where only coordinate information and control IDs are arrayed. If the mode is 1, then it indicates the text mode in part where text is set only to a control ID serving as a marker. If the mode is 2, then it indicates the text mode in entirety where text is set to all control IDs. If the mode is 8, then it indicates the dividing mode where an image which is too large to be displayed once for a control ID is divided into a plurality of images and the images are transmitted. If the mode is 16, then it indicates the multi-action mode where a plurality of processes can be performed with a single control ID if the absolute number of available control IDs is in shortage. The Length represents a message size. The request source ID represents the ID of the information processing device 10. The control ID number represents the number of control IDs (events).

The control ID information comprises request source IDs, flag, and coordinate information. Details shown in FIG. 26 of the control ID information are given at mode=0. In this example, the control ID information represents addresses indicated by flags and coordinate positions for the respective prefixes of the request source IDs.

The flag is represented by 00h/10h indicating test/no text. The flag serves as the positional information of an event. If the flag=11h, it indicates that the event is in an upper left position. x01y01, etc. represents the coordinate information where x0n indicates one or more elements on the horizontal axis and y0m indicates one or more elements on the vertical axis.

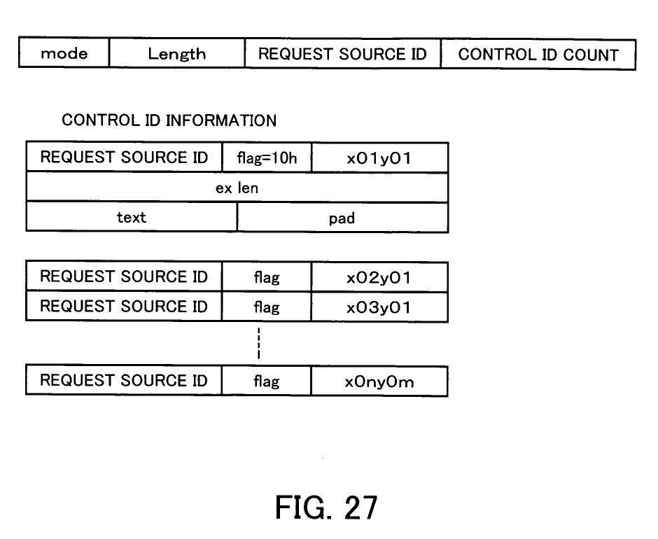

Details shown in FIG. 27 of the control ID information are given at mode=1, 2. In this example, the control ID information represents addresses indicated by flags and coordinate positions for the respective prefixes of the request source IDs. If the flag contains text, then ex len (additional text length), text (text information), and pad (padding information) are added.

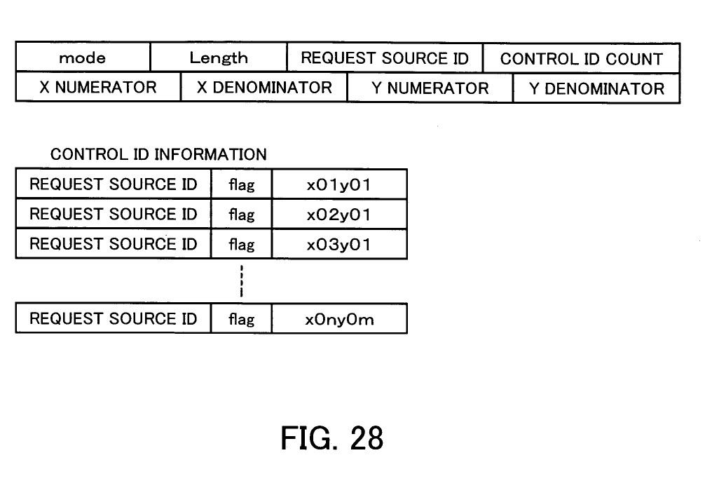

Details shown in FIG. 28 of the control ID information are given at mode=8. In this example, the control ID information represents addresses indicated by flags and coordinate positions for the respective prefixes of the request source IDs. If the flag contains text, then the image information includes x numerators (the number of numerators on the horizontal axis (the present dividing position)), x denominators (the number of denominators on the horizontal axis (the maximum dividing value), y numerators (the number of numerators on the vertical axis (the present dividing position)), and y denominators (the number of denominators on the vertical axis (the maximum dividing value).

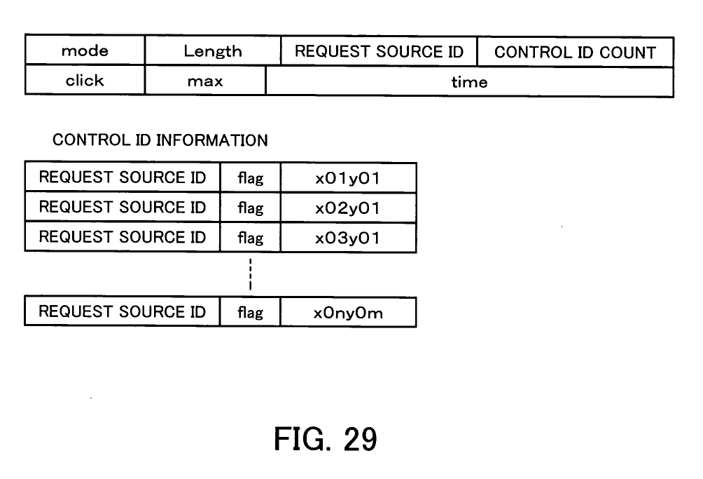

Details shown in FIG. 29 of the control ID information are given at mode=16. In this example, the control ID information represents addresses indicated by flags and coordinate positions for the respective prefixes of the request source IDs. If the flag contains text, then the control ID information includes click (the number of requested clicks), max (the total number of identified clicks), and time (the click accepting time (click waiting time)).

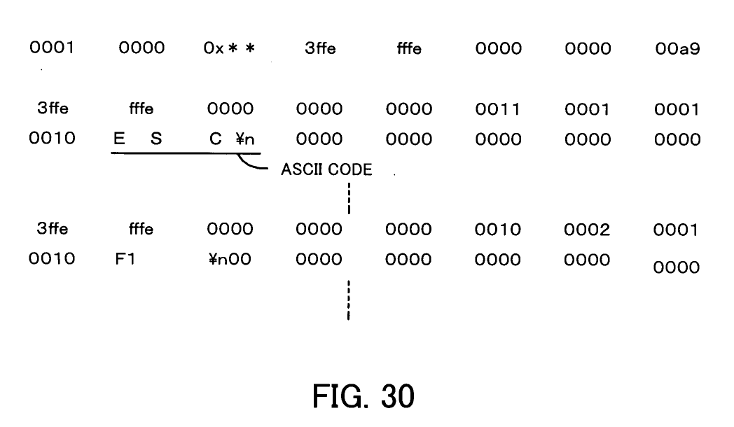

FIG. 30 shows a specific example of event detail information D1. In FIG. 30, the mode is 0001, indicating the text mode. The Length is omitted as the actual number of bytes is included. The request source ID is 3ffe fffe 0000 0000. The control ID number is 109. The control ID information is given below a blank row. The request source ID is 3ffe fffe 0000 0000, and the flag is 0000 0011, indicating the text mode and an LU position. The ex len is 16 bytes, the text is ESC, followed by the padding and F1 below.

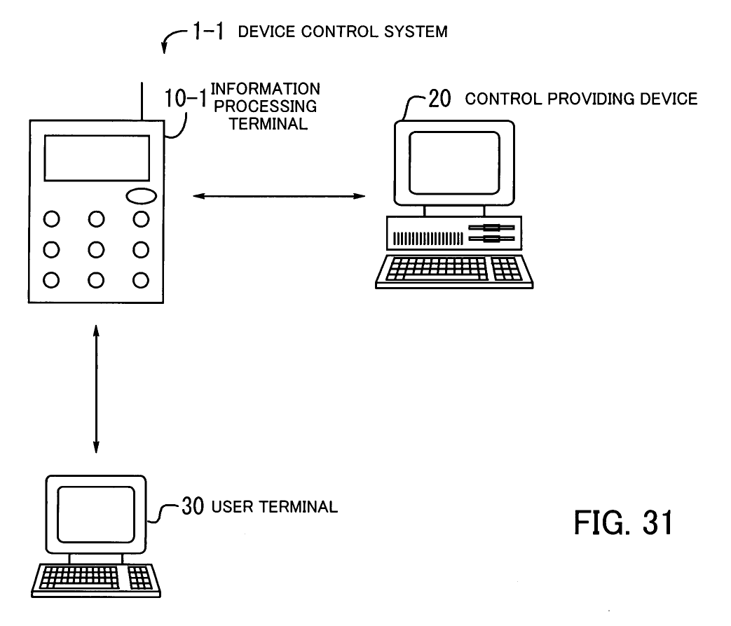

Operation of a modification of the device control system 1 where the information processing terminal 10 is used as a relay terminal will be described below. FIG. 31 shows a device control system for performing relaying operation. A device control system 1-1 comprises an information processing terminal 10-1, a control providing device 20, and a user terminal 30.

The user terminal 30 requests the information processing terminal 10-1 to act as a relay device (a substitute device) between the user terminal 30 and the control providing device 20. The user terminal 30 controls the control providing device 20 through the information processing terminal 10-1. The user terminal 30 and the information processing terminal 10-1 may be connected to each other through a wireless link or a network such as the Internet.

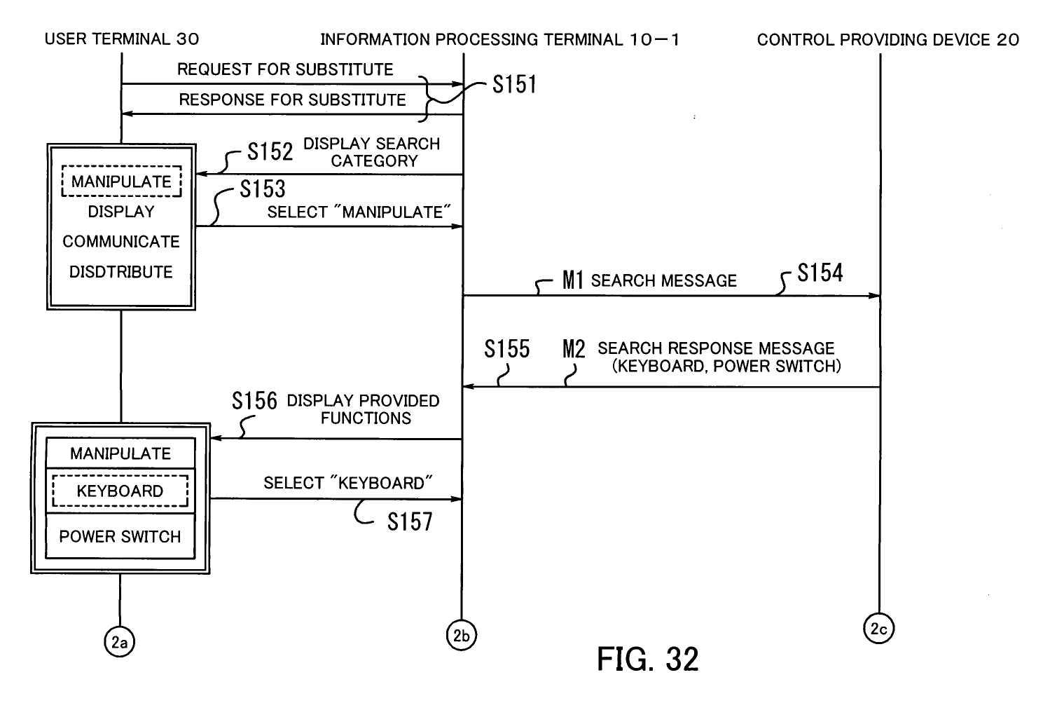

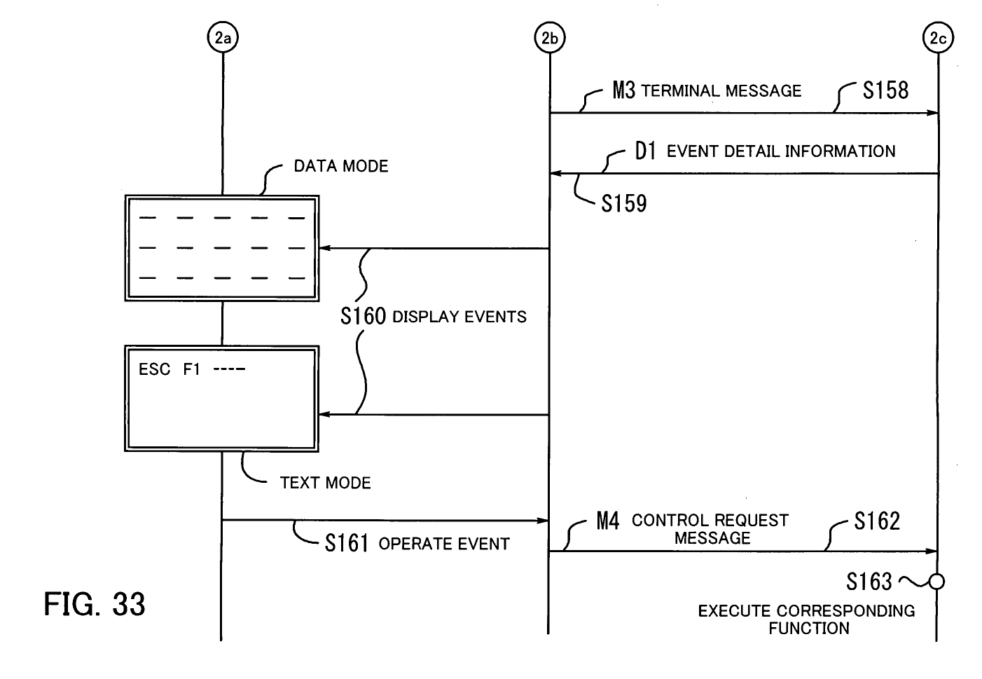

FIGS. 32 and 33 show an operational sequence of the device control system 1-1.

(S151) The user terminal 30 requests the information processing terminal 10-1 to act as a substitute device, and the information processing terminal 10-1 returns a substitute response indicating that it can act as a substitute device. A communication path is now established between user terminal 30 and the information processing terminal 10-1.

(S152) The display controller 13 of the information processing terminal 10-1 displays a search category of control items for the control providing device 20.

(S153) The user selects “MANIPULATE,” for example, from the search category.

(S154) The device searcher 11 of the information processing terminal 10-1 generates a search message M1 including a Category Request (“MANIPULATE” request), and sends the search message M1 to the control providing device 20.

(S155) When the search response processor 21 of the control providing device 20 receives the search message M1, since the Category Request is the “MANIPULATE” request, the search response processor 21 recognizes that the user terminal 30 is to manipulate the control providing device 20. The search response processor 21 adds information representing the keyboard and the power switch as functions that can be provided, to a search response message M2, and sends the search response message M2 to the information processing terminal 10-1.

(S156) The information processing terminal 10-1 receives the search response message M2, and the display controller 13 displays “KEYBOARD” and “POWER SWITCH” on the display screen of the user terminal 30 as the functions provided by the control providing device 20 which correspond to “MANIPULATE.”

(S157) The user selects “KEYBOARD,” for example.

(S158) The control requester 12 of the information processing terminal 10-1 adds the coordinate information of the display screen of the user interface of the user terminal 30 and the ID of the user terminal 30, to a terminal message M3, and sends the terminal message M3 to the control providing device 20 to make a control request.

(S159) The control request response processor 22 of the control providing device 20 receives the terminal message M3, and manages the user terminal 30 as a terminal for operating the control providing device 20, using the ID of the user terminal 30. The control request response processor 22 also recognizes coordinates of the display screen of the user interface of the user terminal 30 from the coordinate information contained in the terminal message M3, assigns events of the keyboard to relative positions of the coordinates to generate event detail information D1, and sends the event detail information D1s to the information processing terminal 10-1.

(S160) The display controller 13 receives the event detail information D1, and displays the events in a display mode based on the event detail information D1 on the display screen of the user terminal 30. In FIG. 33, the events are displayed in both the data mode and the text mode.

(S161) The user operates on one or some of the events displayed on the display screen of the user terminal 30.

(S162) The control request processor 14 of the information processing terminal 10-1 sends a control request message M4 for the corresponding key or keys to the control providing device 20.

(S163) The function executing unit 23 of the control providing device 20 receives the control request message M4 sent from the information processing terminal 10-1, and executes the corresponding function.

As described above, the device control system 1-1 makes it possible not only to search for the control providing device 20, but also to take over controllability of the control providing device 20. Since an information processing terminal is used as a relaying terminal, higher security is achieved if only the information processing terminal with such a function is permitted to be connected. If the size of the display screen is small, too many control requests may be displayed as dots on the display screen or may not be displayed once on the display screen. These problems can be avoided by displaying divided images in the dividing mode.

In FIG. 4, the search message M1 is generated using an ARP frame. However, it may be generated using the MAC frame (Beacon frame) according to IEEE802.11 for wireless LANs, etc.

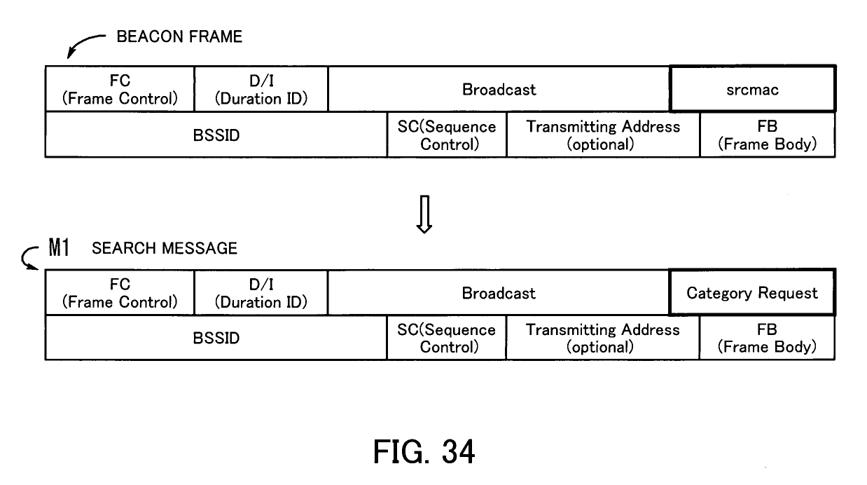

FIG. 34 shows a format of a search message M1 arranged in a Beacon frame. As shown in FIG. 34, a Category Request may be inserted into the srcmac field of the Beacon frame, generating a search message M1.

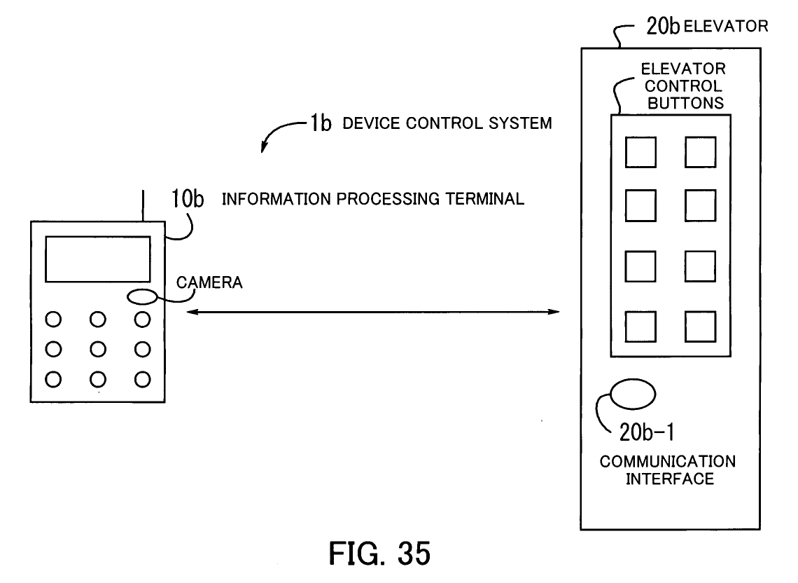

The device control system 1 as applied to an elevator will be described below. FIG. 35 shows a device control system for controlling elevating and lowering movement of an elevator. The device control system, generated denoted by 1b, has an information processing terminal (cellular phone) 10b for displaying elevator control buttons of an elevator 20b, which incorporate the functions of the control providing device 20, on its display screen, and controlling elevating and lowering movement of the elevator 20b through those displayed elevator control buttons. The elevator 20b has a communication interface 20-b1 for communicating with the cellular phone 10b.

FIGS. 36 and 37 show an operational sequence of the device control system 1b for performing elevator control.

(S171) The display controller 13 of the cellular phone 10b displays a search category of control items for the elevator 20b on the display screen of the user interface thereof.

(S172) The user selects “MANIPULATE,” for example, from the search category.

(S173) The device searcher 11 of the cellular phone 10b generates a search message M1 including a Category Request (“MANIPULATE” request), and sends the search message M1 to the elevator 20b.

(S174) When the search response processor 21 of the elevator 20b receives the search message M1, since the Category Request is the “MANIPULATE” request, the search response processor 21 recognizes that the cellular phone 10b is to manipulate the elevator 20b. If the elevator control buttons are available as functions that can be manipulated the cellular phone 10b, then the search response processor 21 adds information representing the elevator control buttons as functions that can be provided, to a search response message M2, and sends the search response message M2 to the cellular phone 10b.

(S175) The cellular phone 10b receives the search response message M2, and the display controller 13 displays “ELEVATOR CONTRTOL BUTTONS” on the display screen of the cellular phone 10b as the functions provided by the elevator 20b which correspond to “MANIPULATE.”

(S176) The user selects “ELEVATOR CONTROL BUTTONS,” for example.

(S177) The control requester 12 of the cellular phone 10b adds the coordinate information of the display screen of the user interface of the cellular phone 10b and the ID of the cellular phone 10b, to a terminal message M3, and sends the terminal message M3 to the elevator 20b to make a control request.

(S178) The control request response processor 22 of the elevator 20b receives the terminal message M3, and manages the cellular phone 10b as a terminal for operating the elevator 20b, using the ID of the cellular phone 10b. The control request response processor 22 also recognizes coordinates of the display screen of the user interface of the cellular phone 10b from the coordinate information contained in the terminal message M3, assigns events of the elevator control buttons to relative positions of the coordinates to generate event detail information D1, and sends the event detail information D1 to the cellular phone 10b.

(S179) The display controller 13 receives the event detail information D1, and displays the events in a display mode based on the event detail information D1 on the display screen of the cellular phone 10b. In FIG. 37, the events are displayed as coordinates indicative of the positions of the elevator control buttons in the data mode, and also displayed as the floor numbers assigned to the elevator control buttons in the text mode.

(S180) The user operates on one or some of the events displayed on the display screen of the cellular phone 10b. The control request processor 14 of the cellular phone 10b sends a control request message M4 for the corresponding elevator control button to the elevator 20b. For example, if the user touches “8F” displayed on the display screen, the control request processor 14 sends a control request message M4 including the floor 8F as an elevator control command to the elevator 20b.

(S181) The function executing unit 23 of the elevator 20b receives the control request message M4 sent from the cellular phone 10b, and executes the corresponding function. In this case, the elevator 20b is lifted or lowered to the floor 8F.

The function executing unit 23 of the elevator 20b accepts a control request only once, for example, from the cellular phone 10b to operate the elevator 20b exclusively only once. Specifically, when the elevator 20b receives the control request for moving to the floor 8F from the cellular phone 10b, the elevator 20b accepts this control request only and moves to the floor 8F only. Therefore, the elevator 8F is prevented from being tampered with.

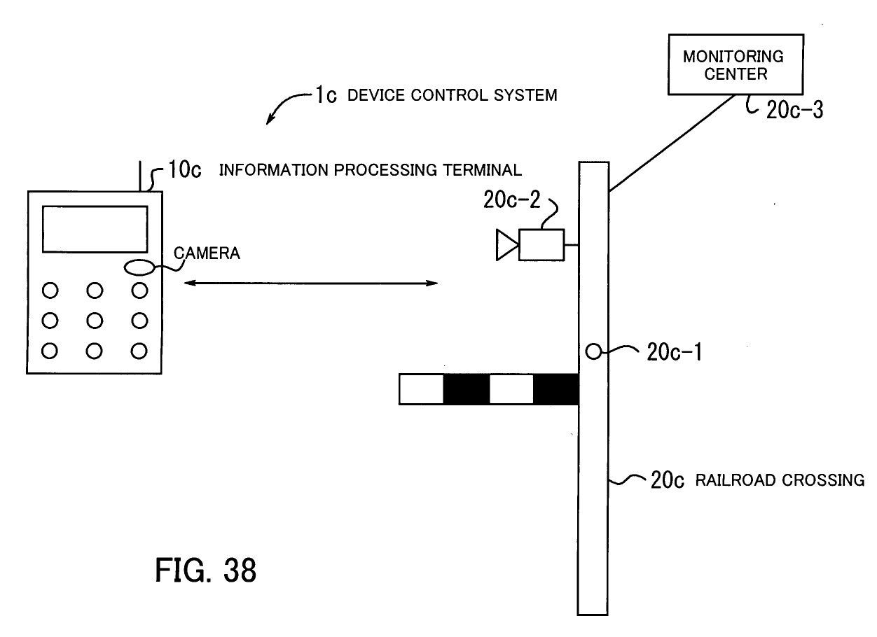

The device control system 1 as applied to sending an alarm message will be described below. FIG. 38 shows a device control system for sending an alarm message. The device control system, generated denoted by 1c, has an information processing terminal (cellular phone) 10c for sending an alarm message to a monitoring center 20c-3 which monitors a railroad crossing 20c incorporating the control providing device 20. The railroad crossing 20c has a communication interface 20c-1 for communicating with the cellular phone 10c and a fixed camera 20c-2.

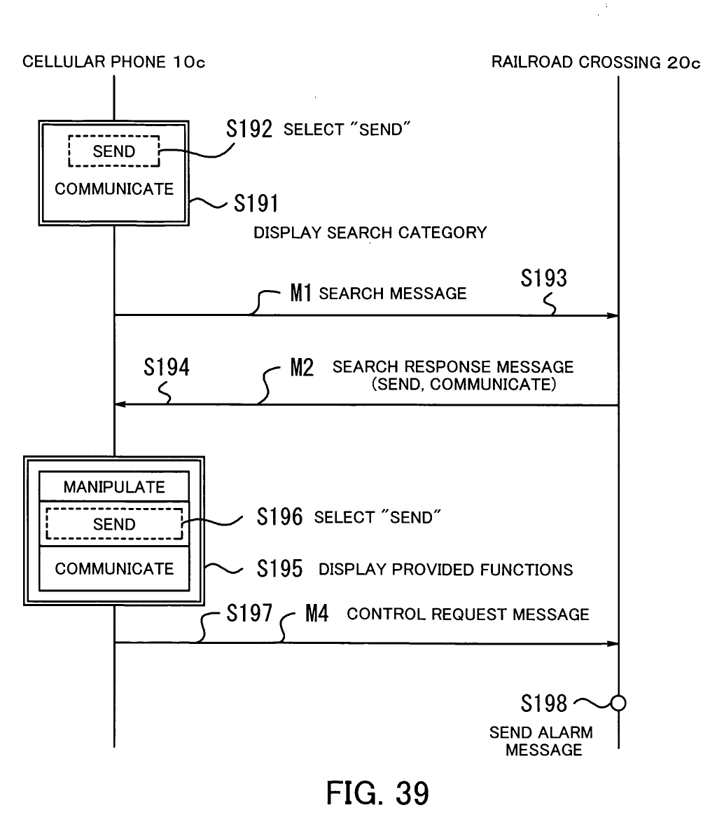

FIG. 39 shows an operational sequence of the device control system 1c for sending an alarm message.

(S191) The display controller 13 of the cellular phone 10c displays a search category of control items for the railroad crossing 20c on the display screen of the user interface thereof.

(S192) The user selects “SEND,” for example, from the search category.

(S193) The device searcher 11 of the cellular phone 10c generates a search message M1 including a Category Request (“SEND” request), and sends the search message M1 to the railroad crossing 20c.

(S194) When the search response processor 21 of the elevator 20c receives the search message M1, since the Category Request is the “SEND” request, the search response processor 21 recognizes that the cellular phone 10c is to send an image captured by the fixed camera 20c-2. The search response processor 21 adds information representing “SEND” and “COMMUNICATE” as functions that can be provided, to a search response message M2, and sends the search response message M2 to the cellular phone 10c.

(S195) The cellular phone 10c receives the search response message M2, and the display controller 13 displays “SEND” on the display screen of the cellular phone 10C.

(S196) The user selects “SEND,” for example.

(S197) The control request processor 14 of the cellular phone 10c sends a control request message M4 to the railroad crossing 20c.

(S198) The function executing unit 23 of the railroad crossing 20c receives the control request message M4 sent from the cellular phone 10c, and sends the image captured by the fixed camera 20c-2 to the monitoring center 20c-3. The device control system 1c is thus capable of immediately notifying the monitoring center 20c-3 of an obstacle that has occurred in the railroad crossing 20c.

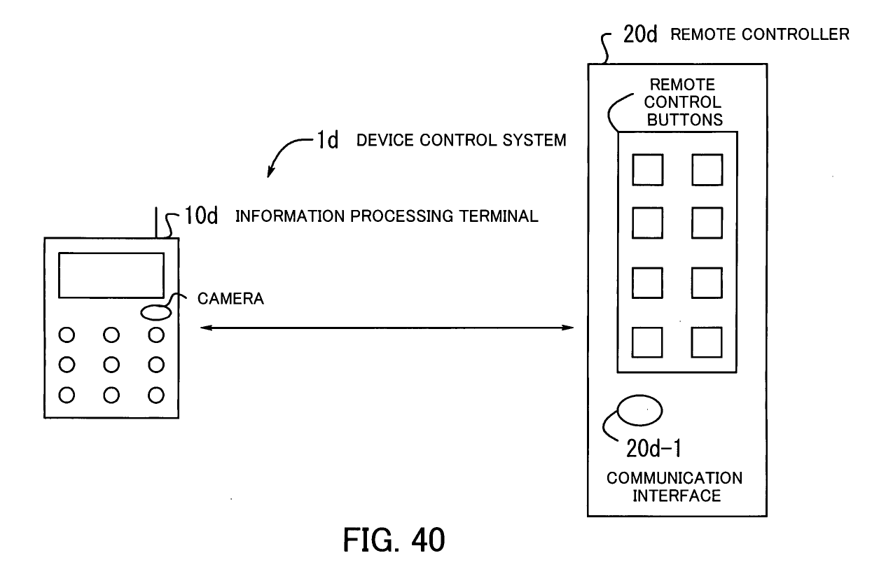

The device control system 1 as applied to controlling a remote controller as the control providing device 20 will be described below. FIG. 40 shows a device control system for controlling a remote controller. The device control system, generated denoted by id, has an information processing terminal (cellular phone) 10d for displaying the remote control buttons of a remote controller 20d which has the functions of the control providing device 20 on the display screen of the information processing terminal 10d, and controlling the remote controller 20d. The remote controller 20d has a communication interface 20d-1 for communicating with the cellular phone 10d.

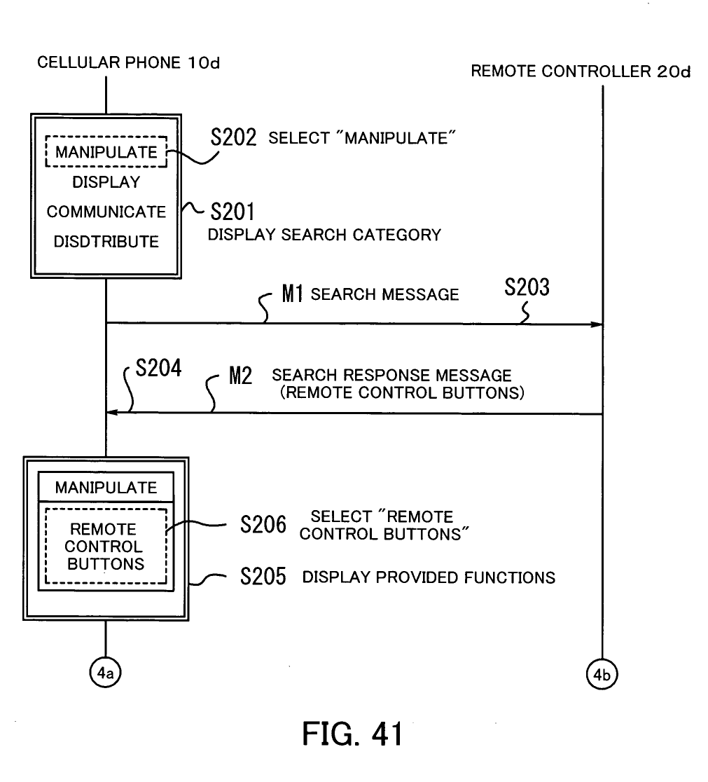

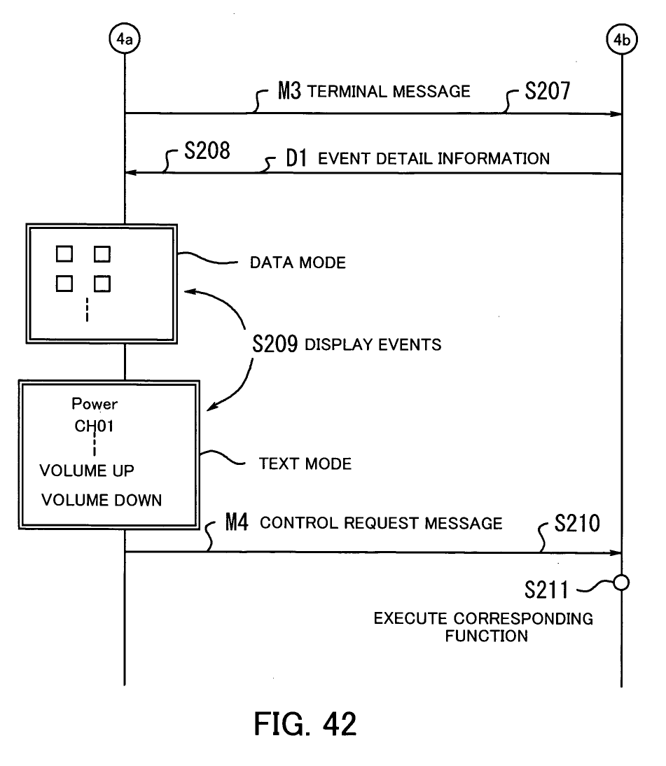

FIGS. 41 and 42 show an operational sequence of the device control system id for controlling the remote controller 20d.

(S201) The display controller 13 of the cellular phone 10d displays a search category of control items for the remote controller 20d on the display screen of the user interface thereof.

(S202) The user selects “MANIPULATE,” for example, from the search category.

(S203) The device searcher 11 of the cellular phone 10d generates a search message M1 including a Category Request (“MANIPULATE” request), and sends the search message M1 to the remote controller 20d.

(S204) When the search response processor 21 of the remote controller 20d receives the search message M1, since the Category Request is the “MANIPULATE” request, the search response processor 21 recognizes that the cellular phone 10d is to manipulate the remote controller 20d. If the remote control buttons are available as functions that can be manipulated by the cellular phone 10d, then the search response processor 21 adds information representing the remote control buttons as functions that can be provided, to a search response message M2, and sends the search response message M2 to the cellular phone 10d.

(S205) The cellular phone 10d receives the search response message M2, and the display controller 13 displays “REMOTE CONTRTOL BUTTONS” on the display screen of the cellular phone 10d as the functions provided by the remote controller 20d which correspond to “MANIPULATE.”

(S206) The user selects “REMOTE CONTROL BUTTONS,” for example.

(S207) The control requester 12 of the cellular phone 10d adds the coordinate information of the display screen of the user interface of the cellular phone 10d and the ID of the cellular phone 10d, to a terminal message M3, and sends the terminal message M3 to the remote controller 20d to make a control request.

(S208) The control request response processor 22 of the remote controller 20d receives the terminal message M3, and manages the cellular phone 10d as a terminal for operating the remote controller 20d, using the ID of the cellular phone 10d. The control request response processor 22 also recognizes coordinates of the display screen of the user interface of the cellular phone 10d from the coordinate information contained in the terminal message M3, assigns events of the remote control buttons to relative positions of the coordinates to generate event detail information D1, and sends the event detail information D1 to the cellular phone 10d.

(S209) The display controller 13 receives the event detail information D1, and displays the events in a display mode based on the event detail information D1 on the display screen of the cellular phone 10d. In FIG. 42, the events are displayed as coordinates indicative of the positions of the remote control buttons in the data mode, and also displayed as the contents of the remote control buttons in the text mode.

(S210) The user operates on one or some of the events displayed on the display screen of the cellular phone 10d. The control request processor 14 of the cellular phone 10d sends a control request message M4 for the corresponding remote control button to the remote controller 20d. For example, if the user touches “CH01” displayed on the display screen, the control request processor 14 sends a control request message M4 including “CH01” as a remote control command to the remote controller 20d.

(S211) The function executing unit 23 of the remote controller 20d receives the control request message M4 sent from the cellular phone 10d, and executes the corresponding function. In this case, the remote controller 20d changes the active channel of a television set to “CH01.”

The device control system 1d as applied to the remote controller 20d allows the cellular phone 10d to operate in the same manner as the remote controller 20d.

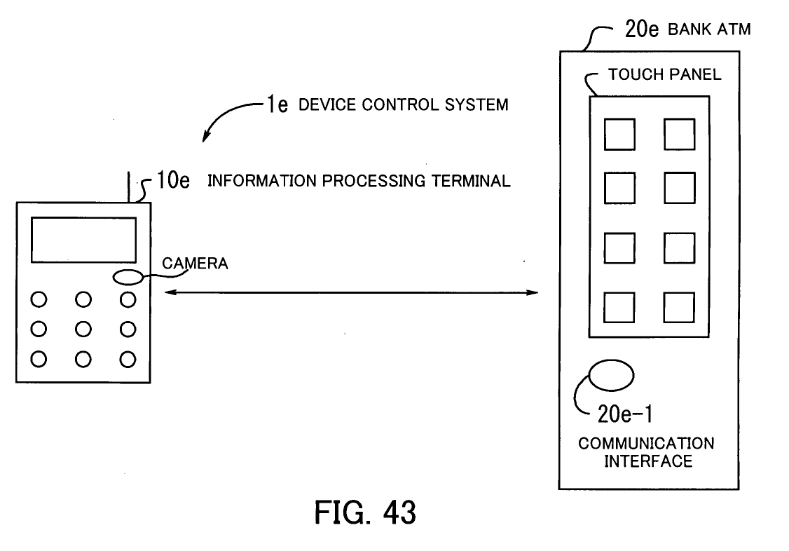

The device control system 1 as applied to a bank ATM (Automatic Teller Machine) will be described below. FIG. 43 shows a device control system for controlling a bank ATM. The device control system, generated denoted by le, has an information processing terminal (cellular phone) 10e for displaying the touch panel of a bank ATM 20e which has the functions of the control providing device 20 on the display screen of the information processing terminal 10e, and controlling the bank ATM 20e. The bank ATM 20e has a communication interface 20e-1 for communicating with the cellular phone 10e.

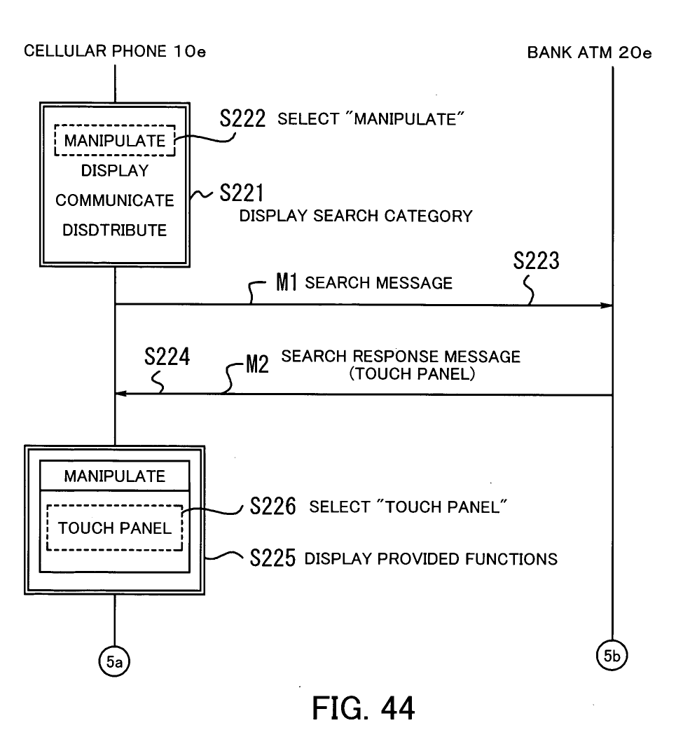

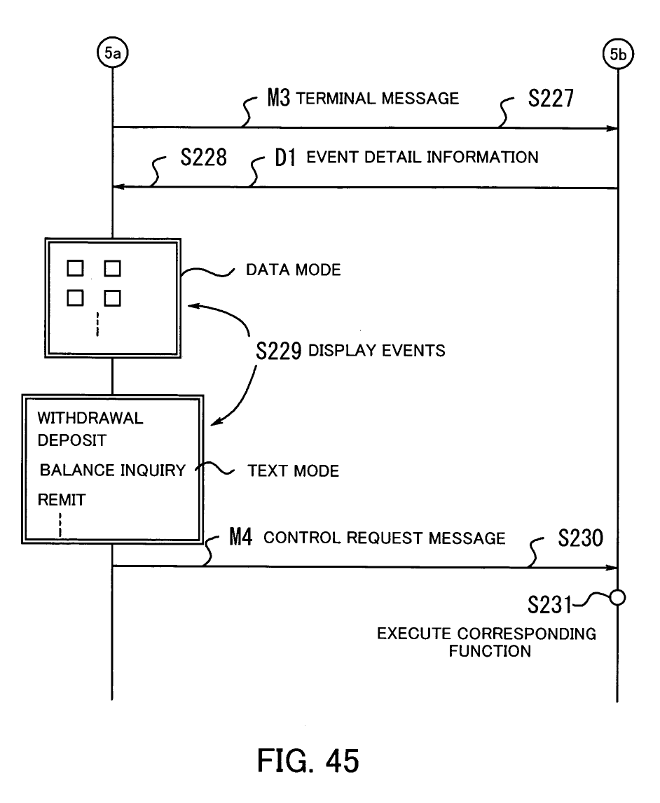

FIGS. 44 and 45 show an operational sequence of the device control system le for controlling the bank ATM 20e.

(S221) The display controller 13 of the cellular phone 10e displays a search category of control items for the bank ATM 20e on the display screen of the user interface thereof.

(S222) The user selects “MANIPULATE,” for example, from the search category.

(S223) The device searcher 11 of the cellular phone 10e generates a search message M1 including a Category Request (“MANIPULATE” request), and sends the search message M1 to the bank ATM 20e.

(S224) When the search response processor 21 of the bank ATM 20e receives the search message M1, since the Category Request is the “MANIPULATE” request, the search response processor 21 recognizes that the cellular phone 10e is to manipulate the bank ATM 20e. If the touch panel is available as a function that can be manipulated by the cellular phone 10e, then the search response processor 21 adds information representing the touch panel as a function that can be provided, to a search response message M2, and sends the search response message M2 to the cellular phone 10e.

(S225) The cellular phone 10e receives the search response message M2, and the display controller 13 displays “TOUCH PANEL” on the display screen of the cellular phone 10e as the function provided by the bank ATM 20e which correspond to “MANIPULATE.”

(S226) The user selects “TOUCH PANEL,” for example.

(S227) The control requester 12 of the cellular phone 10e adds the coordinate information of the display screen of the user interface of the cellular phone 10e and the ID of the cellular phone 10e, to a terminal message M3, and sends the terminal message M3 to the bank ATM 20e to make a control request.

(S228) The control request response processor 22 of the bank ATM 20e receives the terminal message M3, and manages the cellular phone 10e as a terminal for operating the bank ATM 20e, using the ID of the cellular phone 10e. The control request response processor 22 also recognizes coordinates of the display screen of the user interface of the cellular phone 10e from the coordinate information contained in the terminal message M3, assigns events of the touch panel buttons to relative positions of the coordinates to generate event detail information D1, and sends the event detail information D1 to the cellular phone 10e.

(S229) The display controller 13 receives the event detail information D1, and displays the events in a display mode based on the event detail information D1 on the display screen of the cellular phone 10e. In FIG. 45, the events are displayed as coordinates indicative of the positions of the touch panel buttons in the data mode, and also displayed as the contents of the touch panel buttons in the text mode.

(S230) The user operates on one or some of the events displayed on the display screen of the cellular phone 10e. The control request processor 14 of the cellular phone 10e sends a control request message M4 for the corresponding touch panel button to the bank ATM 20e. For example, if the user touches “BALANCE INQUIRY” displayed on the display screen, the control request processor 14 sends a control request message M4 including “BALANCE INQUIRY” as a control command to the bank ATM 20e.

(S231) The function executing unit 23 of the bank ATM 20e receives the control request message M4 sent from the cellular phone 10e, and executes the corresponding function. In this case, the bank ATM 20e displays the amount of money in response to “BALANCE INQUIRY.”

The device control system le as applied to the bank ATM 20e allows the cellular phone 10e to operate in the same manner as the touch panel of the bank ATM 20e. The device control system le thus operated makes it possible to prevent the third party from intercepting the user's confidential information when the user operates the bank ATM 20e. Security can further be enhanced if the user shuffles the positions of touch panel buttons acquired by the cellular phone 10e because only the user knows the shuffled positions of the touch panel buttons.

In the device control system according to the present invention, the information processing terminal sends a terminal message including the coordinate information of the display screen of the user interface and the identifier of the information processing terminal to another device, i.e., the control providing device, to make a control request, and displays events on the display screen based on event detail information sent from the other device. The user operates on one or some of the displayed events to request the other device to perform controlling operation. The control providing device manages the information control terminal as a terminal for manipulating the control providing device, assigns events controllable by the user to the relative positions of coordinates recognized from coordinate information, thereby generating the event detail information. In response to the control request from the information processing terminal, the control providing device performs the corresponding function. In this manner, the device control system allows the information processing terminal owned by the user to control the functions of various connected devices as if through operation panels of those devices.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A device control system for allowing a terminal to control functions of another device, comprising:
an information processing terminal for controlling the functions of the other device through a user interface thereof, the information processing terminal comprising:
a device searcher for sending a search message to search for a device capable of providing control and receiving, a search response message including information about functions that can be provided;
a control requester for sending a terminal message including coordinate information of a display screen of the user interface and an identifier of the information processing terminal for making a control request;
a display controller for displaying on the display screen a search category of control items, the functions that can be provided by the other device, and events in a display mode based on event detail information; and
a control request processor for sending a control request message to the other device in response to operation of the events displayed on the display screen; and
a control providing device for performing functions thereof according to the control request from the information processing terminal, the control providing device comprising:
a search response processor for receiving the search message and returning the search response message;
a control request response processor for receiving the terminal message, managing the information processing terminal as a terminal for controlling the control providing device based on the identifier, assigning events controllable by the user to relative positions of coordinates recognized from the coordinate information, thereby generating the event detail information, and sending the event detail information; and
a function executing unit for receiving the control request message and executing a function corresponding thereto.

2. The device control system according to claim 1, wherein the information processing terminal further comprises:
an image capturing unit for capturing an image of a user interface of the control providing device and acquiring the captured image;
wherein the display controller pastes the captured image positionally adjustably onto the displayed events.

3. The device control system according to claim 2, wherein the control request response processor sends the event detail information including positional information of the events, and the display controller applies a mark to coordinates on the display screen which correspond to the positional information, and wherein the image capturing unit captures an image of the user interface of the control providing device in alignment with the mark applied to the coordinates, and the display controller pastes the captured image onto the displayed events.

4. The device control system according to claim 1, wherein the display controller displays the events at a different angle or divides the events into a plurality of images, and wherein when the display controller divides the events into a plurality of images, the display controller associates the divided images with different numbers of clicks on the events per unit time.

5. The device control system according to claim 1, wherein the control request processor accumulates operated events, and sends the accumulated events altogether on the control request message.

6. The device control system according to claim 1, wherein the control providing device further comprises:
a connected state manager for periodically monitoring the intensity of a radio wave transmitted from the information processing terminal, deleting the information processing terminal from managed terminals if the monitored intensity of the radio wave is lower than a threshold level, managing the information processing terminal as a terminal for operating the control providing device by monitoring the information processing terminal based on a timer if the monitored intensity of the radio wave exceeds the threshold level, and deleting the information processing terminal from managed terminals if the control providing apparatus is not accessed from the information processing terminal within an effective time set by the timer.

7. The device control system according to claim 1, wherein the function executing unit accepts the control request from the information processing terminal only a preset number of times, and executes the corresponding function exclusively by the preset number of times.

8. The device control system according to claim 1, wherein the control request response processor sends information representing a combination of the functions which can be provided by the control providing device, based on the identifier of the information processing terminal, as the event detail information.

9. The device control system according to claim 1, wherein the device searcher generates the search message in a multi-frame format with a flag representing a data frame or a synchronous frame, the search message including a category request if the flag represents the synchronous frame.

10. The device control system according to claim 9, wherein the device searcher includes mask information representing whether data is valid or not, in the category request.

11. The device control system according to claim 9, wherein the device searcher generates the search message in an ARP frame or a Beacon frame.

12. The device control system according to claim 1, wherein when the search response processor receives the search message, the search response processor performs a process of matching the search message against a device information table managed for each of the control items to determine whether the search message is addressed to the control providing device or not, and the search response processor sends the search response message if the search message matches the device information table.

13. An information processing terminal for controlling functions of another device through a user interface thereof, the information processing terminal comprising:
a device searcher for sending a search message to search for a device capable of providing control and receiving a search response message including information about functions that can be provided;
a control requester for sending a terminal message including coordinate information of a display screen of the user interface and an identifier of the information processing terminal for making a control request;
a display controller for displaying on the display screen a search category of control items, the functions that can be provided by the other device, and events in a display mode based on event detail information; and
a control request processor for sending a control request message to the other device in response to operation of the events displayed on the display screen.

14. The information processing terminal according to claim 13, further comprising:
an image capturing unit for capturing an image of a user interface of a device capable of providing control and acquiring the captured image;
wherein the display controller pastes the captured image positionally adjustably onto the displayed events.

15. The information processing terminal according to claim 14, wherein when the display controller receives the event detail information including positional information of the events, the display controller applies a mark to coordinates on the display screen which correspond to the positional information, and wherein the image capturing unit captures an image of the user interface of a device capable of providing control in alignment with the mark applied to the coordinates, and the display controller pastes the captured image onto the displayed events.

16. The information processing terminal according to claim 13, wherein when the display controller displays the events at a different angle or divides the events into a plurality of images, and wherein when the display controller divides the events into a plurality of images, the display controller associates the divided images with different numbers of clicks on the events per unit time.

17. The information processing terminal according to claim 13, wherein the control request processor accumulates operated events, and sends the accumulated events altogether on the control request message.

18. The information processing terminal according to claim 13, wherein the device searcher generates the search message in a multi-frame format with a flag representing a data frame or a synchronous frame, the search message including a category request if the flag represents the synchronous frame.

19. The information processing terminal according to claim 18, wherein the device searcher includes mask information representing whether data is valid or not, in the category request.

20. The information processing terminal according to claim 18, wherein the device searcher generates the search message in an ARP frame or a Beacon frame.

21. A control providing device for performing functions thereof according to a control request from a terminal, comprising:
a search response processor for receiving a search message for searching for a device which is capable of providing control and returning a search response message including information about functions that can be provided;
a control request response processor for receiving a terminal message including coordinate information of a display screen of a user interface and an identifier of the terminal, managing the terminal as a terminal for controlling the control providing device based on the identifier, assigning events controllable by the user to relative positions of coordinates recognized from the coordinate information, thereby generating event detail information, and sending the event detail information; and
a function executing unit for receiving a control request message from the terminal and executing a function corresponding thereto.

22. The control providing device according to claim 21, wherein the control request response processor sends the event detail information including positional information of the events.

23. The control providing device according to claim 21, further comprising:
a connected state manager for periodically monitoring the intensity of a radio wave transmitted from the terminal, deleting the terminal from managed terminals if the monitored intensity of the radio wave is lower than a threshold level, managing the terminal as a terminal for operating the control providing device by monitoring the terminal based on a timer if the monitored intensity of the radio wave exceeds the threshold level, and deleting the terminal from managed terminals if the control providing apparatus is not accessed from the terminal within an effective time set by the timer.

24. The control providing device according to claim 21, wherein the function executing unit accepts a control request from the terminal only a preset number of times, and executes the corresponding function exclusively by the preset number of times.

25. The control providing device according to claim 21, wherein the control request response processor sends information representing a combination of the functions which can be provided by the control providing device, based on the identifier of the terminal, as the event detail information.

26. The control providing device according to claim 21, wherein when the search response processor receives the search message, the search response processor performs a process of matching the search message against a device information table managed for each of the control items to determine whether the search message is addressed to the control providing device or not, and the search response processor sends the search response message if the search message matches the device information table.

27. A device control system for allowing a terminal to control functions of another device, comprising:
a user terminal operable by the user;
an information processing terminal for acting as a substitute terminal for the user terminal and controlling the functions of the other device through a user interface of the user terminal, the information processing terminal comprising:
a device searcher for sending a search message to search for a device capable of providing control and receiving a search response message including information about functions that can be provided;
a control requester for sending a terminal message including coordinate information of a display screen of the user interface of the user terminal and an identifier of the user terminal for making a control request;
a display controller for displaying on the display screen of the user terminal a search category of control items, the functions that can be provided by the other device, and events in a display mode based on event detail information; and
a control request processor for sending a control request message to the other device in response to operation of at least one of the events displayed on the display screen of the user terminal; and
a control providing device for performing functions thereof according to the control request from the user terminal, the control providing device comprising:
a search response processor for receiving the search message and returning the search response message;
a control request response processor for receiving the terminal message, managing the information processing terminal as a terminal for controlling the control providing device based on the identifier, assigning events controllable by the user to relative positions of coordinates recognized from the coordinate information, thereby generating the event detail information, and sending the event detail information; and
a function executing unit for receiving the control request message and executing a function corresponding thereto.

28. A device control system for controlling lifting and lowering movement of an elevator from a terminal, comprising:
an information processing terminal for controlling lifting and lowering movement of the elevator through a user interface thereof, the information processing terminal comprising:
a device searcher for sending a search message to search for an elevator capable of providing control and receiving a search response message including information about functions that can be provided;
a control requester for sending a terminal message including coordinate information of a display screen of a user interface of the information processing terminal and an identifier of the information processing terminal for making a control request;
a display controller for displaying on the display screen of the information processing terminal elevator control buttons of the elevator as events, based on event detail information; and
a control request processor for sending a control request message for lifting and lowering functions of the elevator in response to operation of the displayed elevator control buttons; and
an elevator device for lifting and lowering the elevator according to the control request from the information processing terminal, the elevator device comprising:
a search response processor for receiving the search message and returning the search response message;
a control request response processor for receiving the terminal message, managing the information processing terminal as a terminal for controlling the elevator based on the identifier, assigning the elevator control buttons of the elevator which are controllable by the user to relative positions of coordinates recognized from the coordinate information, thereby generating the event detail information, and sending the event detail information; and
a function executing unit for receiving the control request message and executing lifting and lowering movement of the elevator corresponding thereto.

29. A device control system for controlling remote control buttons on a remote controller from a terminal, comprising:
an information processing terminal for controlling the remote control buttons through a user interface thereof, the information processing terminal comprising:
a device searcher for sending a search message to search for a remote controller capable of providing control and receiving a search response message including information about functions that can be provided;
a control requester for sending a terminal message including coordinate information of a display screen of a user interface of the information processing terminal and an identifier of the information processing terminal for making a control request;
a display controller for displaying on the display screen of the information processing terminal the remote control buttons as events, based on event detail information; and
a control request processor for sending a control request message for remote control button functions of the remote controller in response to operation of the displayed remote control buttons; and
a remote controller device for operating the remote control buttons of the remote controller according to the control request from the information processing terminal, the remote controller device comprising:
a search response processor for receiving the search message and returning the search response message;
a control request response processor for receiving the terminal message, managing the information processing terminal as a terminal for controlling the remote controller based on the identifier, assigning the remote control buttons on the remote controller which are controllable by the user to relative positions of coordinates recognized from the coordinate information, thereby generating the event detail information, and sending the event detail information; and
a function executing unit for receiving the control request message and executing operation of the remote control buttons corresponding thereto.

30. A device control system for controlling a touch panel of a bank ATM from a terminal, comprising:
an information processing terminal for controlling the touch panel of the bank ATM through a user interface thereof, the information processing terminal comprising:
a device searcher for sending a search message to search for a bank ATM capable of providing control and receiving a search response message including information about functions that can be provided;
a control requester for sending a terminal message including coordinate information of a display screen of a user interface of the information processing terminal and an identifier of the information processing terminal for making a control request;
a display controller for displaying on the display screen of the information processing terminal touch panel buttons of the bank ATM as events, based on event detail information; and
a control request processor for sending a control request message for touch panel functions of the bank ATM in response to operation of the displayed touch panel buttons; and
a bank ATM device for operating the touch panel of the bank ATM according to the control request from the information processing terminal, the bank ATM device comprising:
a search response processor for receiving the search message and returning the search response message;
a control request response processor for receiving the terminal message, managing the information processing terminal as a terminal for controlling the bank ATM based on the identifier, assigning the touch panel buttons of the bank ATM which are controllable by the user to relative positions of coordinates recognized from the coordinate information, thereby generating the event detail information, and sending the event detail information; and
a function executing unit for receiving the control request message and executing operation of the touch panel buttons corresponding thereto.
